(19) United States
(12) Patent Application Publication
(10) Pub. No.: US 2013/0282508 A1
(43) Pub. Date: Oct. 24, 2013

(54) SYSTEM AND METHOD FOR IDENTIFYING AND PURCHASING RETAIL PRODUCTS

(71) Applicants: Gary Oberman, Montreal (CA); Bartlorniej Bulzak, Candiac (CA)

(72) Inventors: Gary Oberman, Montreal (CA); Bartlorniej Bulzak, Candiac (CA)

(73) Assignee: Buildablock Corp., Montreal (CA)

(21) Appl. No.: 13/769,083

(22) Filed: Feb. 15, 2013

Related U.S. Application Data
(63) Continuation of application No. 13/495,117, filed on Jun. 13, 2012.
(60) Provisional application No. 61/635,194, filed on Apr. 18, 2012.

(51) Int. Cl. G06Q 30/06

(52) U.S. Cl. CPC G06Q 30/0605
USPC 705/26.2

(57) ABSTRACT

A System and Method For Identifying and Purchasing Retail Products is disclosed. The system allows a community of members to communicate and interact with one another. A member or members of the community may provide information related to a desired product or service to the community of members who may then collectively create an aggregate purchase offer for the desired product or service to a merchant or merchants. The system further provides a mechanism for the merchant to either accept the aggregate purchase price or to provide a counter-offer, and further provides a mechanism for members of the community of members to either accept the counter-offer or to provide a new counter-offer to the merchant. The system and related methods may further interoperate with social networking systems and methods and provide social networking abilities to the community of members.

### CROSS-REFERENCE TO RELATED PATENT APPLICATIONS

This application claims the benefit of the filing date of U.S. Provisional Patent Application No. 61/635,194 filed on Apr. 18, 2012, and is a continuation of U.S. application Ser. No. 13/495,117 filed on Jun. 13, 2012.

### BACKGROUND OF THE INVENTION

1. Field of the Invention

This invention relates generally to electronic commerce, and more particularly to a computer based system and method for identifying and purchasing retail products.

2. Description of Related Art

Historically, the act of buying and selling has taken on several distinct modalities. In recent years, the ability to negotiate a purchase price has been fairly limited, particularly with retail establishments and traditional storefronts. Even with the tremendous upwelling of internet purchasing, pricing is typically fixed by the seller. Be it traditional storefront or internet selling, the seller usually determines the purchase price based on variables such as fixed costs to produce or wholesale purchase the product, supply and demand, and the like. Seller based pricing using supply and demand criteria often involves determining supply and demand from historical data. This approach has numerous flaws. The demand for a product using seller based pricing is driven largely by the actions taken by the seller to market and price their product or service. As demand and related volume goes up, the seller is faced with a pricing decision. If the seller elects to increase price, demand could drop quickly and be harmful to the seller. On the other hand, if the seller lowers the price for the product or service to increase demand and related volume, the seller may enjoy increased profits even at a lower price due to the volume of product or service being sold. This approach to seller based pricing puts control of the transaction in the hands of the seller, with a potential buyer either being willing to accept the price of the seller, or moving on to find a different seller with a different price and perhaps a different product altogether. This one sided transactional model where the seller establishes a fixed price is not always best for either buyer or seller, but is typical of how goods and services are sold today, with very few exceptions.

One of the few exceptions to the seller fixed price model is that of auctions. Auctions, particularly on-line auctions, give a potential buyer the ability to bid on a single item from a single seller, and have become extremely popular in recent years. This model gives the buyer the ability to partly control the price, with the ultimate acceptance or rejection of the price being with the seller. Auctions, while giving the buyer more control over pricing, are still a single buyer, single seller model.

Another exception to the seller fixed price model is in corporate purchasing, where the sheer volume of a potential purchase provides the buyer with incredible negotiating power. The buyer is typically a large corporation or government entity, and has a formal process for purchasing and obtaining favorable pricing that includes purchasing staff, request for pricing/request for proposal processes, and the like. The ability to negotiate and wield purchasing power is, however, virtually non-existent with a single potential buyer except for some high dollar amount items where a single purchase becomes important to a seller.

It is therefore an object of the present invention to provide a system and method for identifying and purchasing retail products. It is another object of the present invention to provide a system and method for aggregating buyers in order to generate a volume-discounted price to the advantage of the buyers, while at the same time generating higher-volume sales to the advantage of the selling merchants. It is another object of the present invention to provide a system and method for negotiating between a group of potential buyers and a seller. It is another object of the present invention to provide a system and method for providing a community of members with an environment to communicate and interact regarding potential purchases of products or services. It is yet another object of the present invention to provide a community of members in a social networking system with a method for aggregating purchase offers for a product or service. It is another object of the present invention to provide a system and method for identifying and purchasing retail products that interfaces with a social networking system or method. These and other objects of the present invention will become evident to one skilled in the art after a review of this specification, claims, and the attached drawings.

### BRIEF SUMMARY OF THE INVENTION

In accordance with the present invention, there is provided a system and method for identifying and purchasing retail products that involves the steps of creating a community of members where the community of members are connected by a network; identifying by a member of the community of members a desired product or service; uploading information related to the desired product or service to a network; making the information related to the desired product or service available to members of the community of members based on a selection criteria; aggregating purchase offers for the desired product or service from members of the community of members; transmitting to a merchant an aggregate purchase price and a quantity of purchase offers from members of the community of members; providing a mechanism for the merchant to either accept the aggregate purchase price or to provide a counter-offer comprising a new purchase price; and providing a mechanism for members of the community of members to either accept the counter-offer or to provide a new counter-offer to the merchant.

The foregoing paragraph has been provided by way of introduction, and is not intended to limit the scope of this invention as defined by this specification, claims, and the attached drawings.

### BRIEF DESCRIPTION OF THE DRAWINGS

The invention will be described by reference to the following drawings, in which like numerals refer to like elements, and in which:

FIG. 1 is an overview network diagram showing the connections between members, merchants, and products as established and maintained by the invention;

FIG. 2 is a top level block diagram showing the principal components of the invention;

FIG. 3 is a conceptual flow diagram depicting the logical components of the present invention and their paths of interaction;

FIG. 4 is a conceptual flow diagram depicting the logical components of the present invention and their paths of interaction when a member proposes a deal;

FIG. 5 is a conceptual flow diagram depicting the logical components of the present invention and their paths of interaction when the community of members selects a product;

FIG. 6 is a conceptual flow diagram depicting the logical components of the present invention and their paths of interaction when the invention joins members as buyers of a selected product;

FIG. 7 is a conceptual flow diagram depicting the logical components of the present invention and their paths of interaction when the joined buyers select a merchant of a selected product;

FIG. 8 is a conceptual flow diagram depicting the logical components of the present invention and their paths of interaction when the joined buyers negotiate a deal with a merchant of a selected product;

FIG. 9 is a process flow diagram depicting the present invention's process of negotiation from start through merchant negotiation confirmation;

FIG. 10 is a process flow diagram depicting the present invention's process of negotiation from community of members counter offer through completion;

FIG. 11 is a flowchart depicting the present invention's process of negotiation from community of members counter offer through completion, indicating conditional alternatives in processing;

FIG. 12 is an exemplary screenshot for setup of an aggregate purchase offer;

FIG. 13 is an exemplary screenshot of a desired product or service in a page;

FIG. 14 is an exemplary screenshot of a desired product or service with deal preparation dialog;

FIG. 15 is an exemplary screenshot of product details;

FIG. 16 is an exemplary screenshot of merchant details;

FIG. 17 is an exemplary screenshot of a welcome to a member of a community of members;

FIG. 18 is an exemplary screenshot of a sales lead;

FIG. 19 is an exemplary screenshot for choosing a kind of aggregate purchase offer;

FIG. 20 is an exemplary screenshot for creating an aggregate purchase offer;

FIG. 21 is an exemplary screenshot for joining a community of members deal;

FIG. 22 is an exemplary screenshot of a phone app new aggregate purchase offer empty;

FIG. 23 is an exemplary screenshot of a phone app new aggregate purchase offer half filled;

FIG. 24 is an exemplary screenshot of a phone app new aggregate purchase offer typing;

FIG. 25 is an exemplary screenshot of sharing options for a member of a community of members (wifi share);

FIG. 26 is an exemplary screenshot of existing deals with a large map;

FIG. 27 is an exemplary screenshot of a product list in a specific product category;

FIG. 28 is an exemplary screenshot of products;

FIG. 29 is an exemplary screenshot of product detail login;

FIG. 30 is an exemplary screenshot of product detail FACEBOOK™;

FIG. 31 is an exemplary screenshot of product detail joined;

FIG. 32 is an exemplary screenshot of a merchant begin negotiation;

FIG. 33 is an exemplary screenshot of a merchant begin negotiation buyer count check;

FIG. 34 is an exemplary screenshot of a merchant begin negotiation confirm;

FIG. 35 is an exemplary screenshot of a community of members offer accepted;

FIG. 36 is an exemplary screenshot of a community of members voucher;

FIG. 37 is an exemplary screenshot of a community of members counter offer;

FIG. 38 is an exemplary screenshot of a community of members counter offer confirm;

FIG. 39 is an exemplary screenshot of a community of members counter offer payment;

FIG. 40 is an exemplary screenshot of a merchant counter offer;

FIG. 41 is an exemplary screenshot of a merchant counter offer quantity;

FIG. 42 is an exemplary screenshot of a merchant counter offer confirm;

FIG. 43 is an exemplary screenshot of a community of members' final choice;

FIG. 44 is an exemplary screenshot of a community of members final choice confirm;

FIG. 45 is an exemplary screenshot of messages for a member of a community of members (member ‘dashboard’);

FIG. 46 is an exemplary screenshot of aggregate purchase offers for a member of a community of members (member ‘dashboard’);

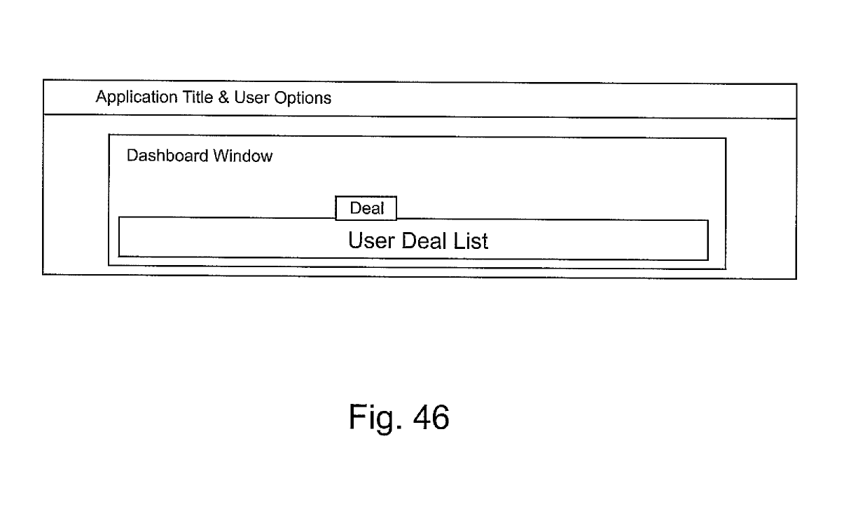

FIG. 47 is an exemplary screenshot of a profile for a member of a community of members (member ‘dashboard’);

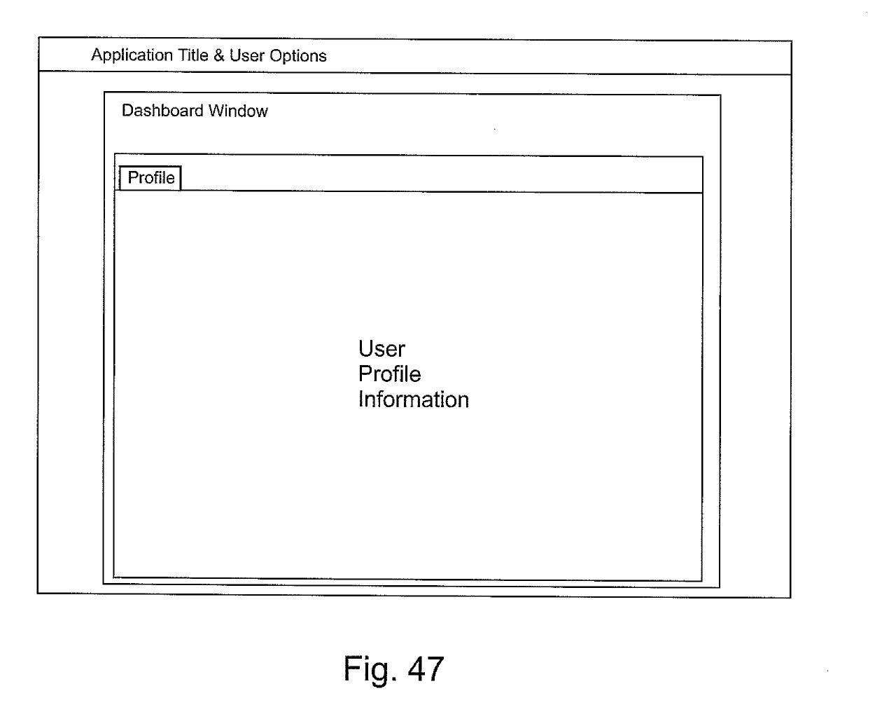

FIG. 48 is an exemplary screenshot of settings for a member of a community of members (member ‘dashboard’); and

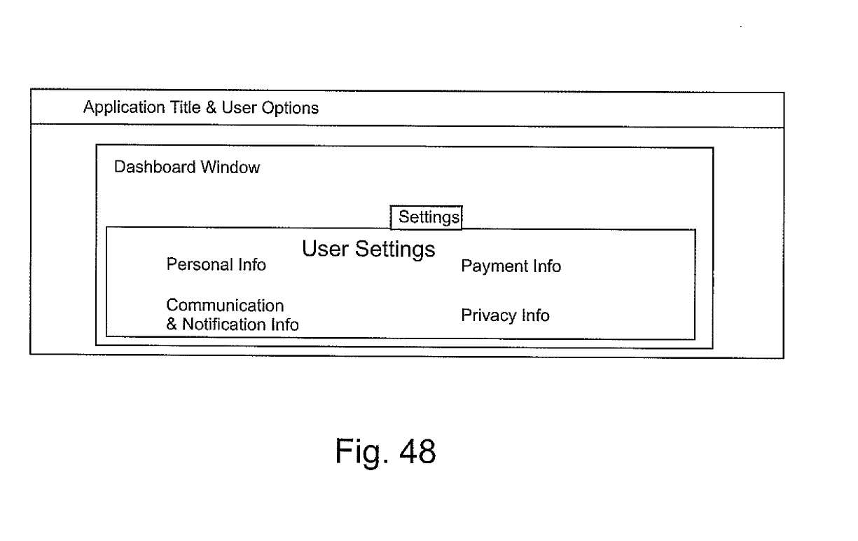

FIG. 49 is an exemplary screenshot of vouchers for a member of a community of members (member ‘dashboard’).

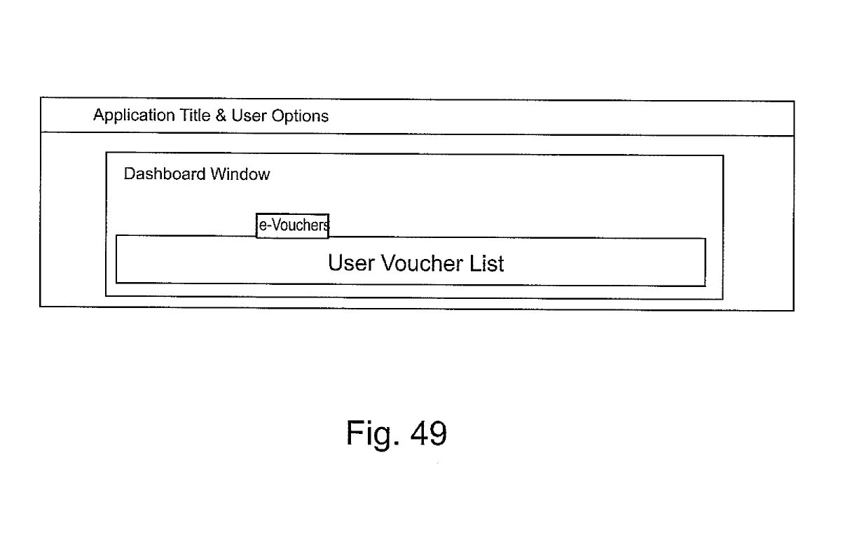

### DESCRIPTION OF THE PREFERRED EMBODIMENTS

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

For a general understanding of the present invention, reference is made to the drawings. In the drawings, like reference numerals have been used throughout to designate identical elements.

The present invention will be described in connection with a preferred embodiment; however, it will be understood that there is no intent to limit the invention to the embodiment described. On the contrary, the intent is to cover all alternatives, modifications, and equivalents as may be included within the spirit and scope of the invention as defined by this specification, claims, and the attached drawings.

### Overview Flow

The present invention and the various embodiments described, depicted and envisioned herein provide a system and method for combining price aggregation and volume-limited discounts to targeted groups of buyers, with different classes of goods and services and different pricing strategies, and presenting deals dynamically from a grouping of potential buyers (consumers) to a vendor or similar selling entity, with the goal of facilitating a transaction.

Both consumers and merchants enter the system of the present invention in some embodiments by becoming members of a community that has been created or is managed or otherwise operable with the system of the present invention. The signup process may be conducted via social media channels (e.g., FACEBOOK™), by electronic mail, or in combination with other electronic or non-electronic means. By signing up, a consumer gains access to the system's range of available deals, to the merchants offering deals for purchase, and to other consumers who are already members of the invention's community. Regardless of how consumers enter the system, they are continuously encouraged to explore each new avenue as presented.

If the consumer becomes a member of a potential deal and navigates these choices to an endpoint, the present invention facilitates the deal on a revenue, referral or commission basis. If the member hesitates in the purchase, the invention presents additional options, each one invoking a subsystem to retrieve fresh options. For example, if the pricing is too high for the ideal product, the invention may confirm that “used” is a viable choice, and begin searching its known areas for used products. The member acting as one of a group is presented with ongoing procurement auctions with an option to participate. The present invention, in some embodiments, is designed and constructed with the option to integrate “extensions” such as free product giveaways, bartering, coupon searches, auctions, repossession and bankruptcy listings, retail demonstration units, end-of-lease and reconditioned products, product unbundling and more. Analogous “extensions” are planned for service procurement, making the present invention an aggressive and comprehensive system for facilitating rapid and optimal purchasing by buyers.

At a level of importance equal to that for buyers, the present invention offers participating merchants the same avenues of presentation for their products and services, with intelligent suggestions based on search data returned (for example, “where are people shopping for this product these days”)? In models where direct negotiations are part of conventional procurement practices, the present invention, in some embodiments, offers such services as online negotiation tools (messaging), transaction security (escrow), and facilitation (shipping brokerage, landed cost calculations, packaging, insurance etc.) using the same mechanism—sourced from the present invention's listed suppliers or retrieved by the present invention.

Thus, potential buyers are able to aggregate their combined purchasing power to facilitate transactions with price points heretofore not possible without the use of the present invention. Buyers receive better pricing and selection than heretofore possible, and merchants or similar sellers receive additional business through aggregation of orders. The sophistication presented by the community of members and the social networking provided in combination with the transactional nature of the present invention provide novelty and utility to electronic commerce that has not been possible prior to the present invention.

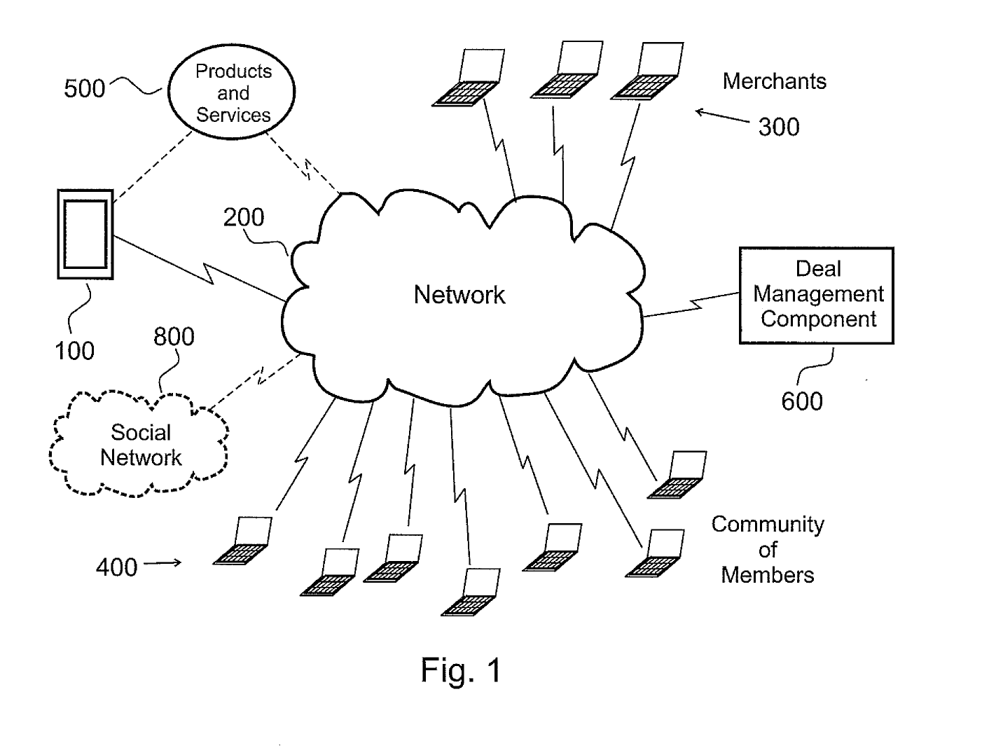

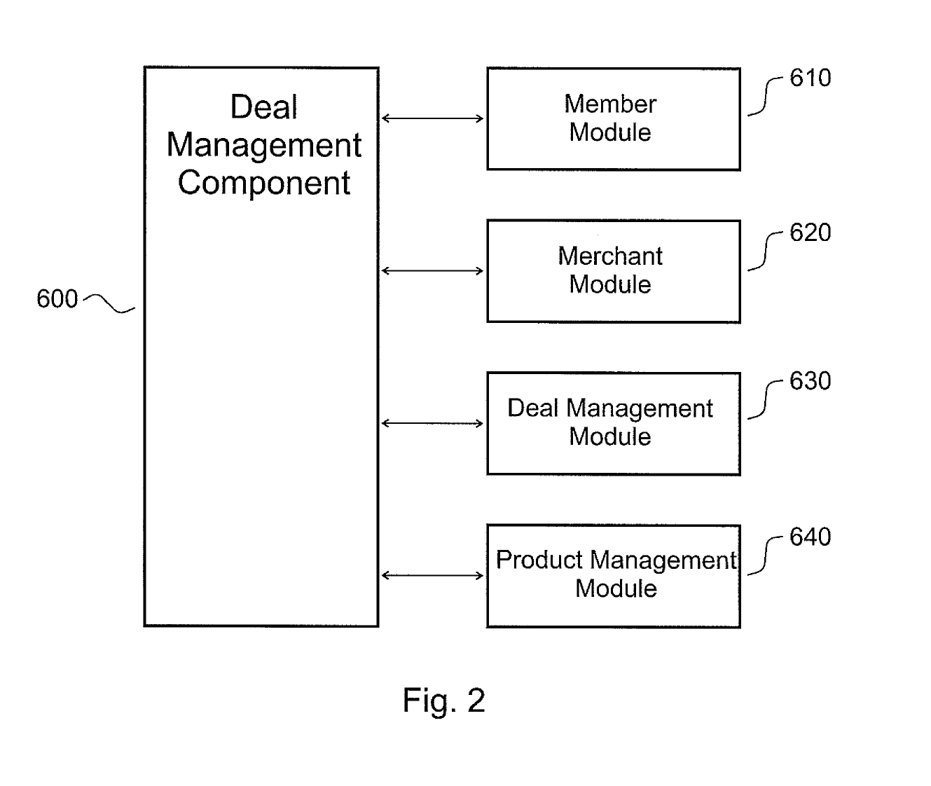

For a general understanding of the present invention, reference is made to the drawings. In the drawings, like reference numerals have been used throughout to designate identical elements. Referring now to FIG. 1, the present invention comprises a computer 100 having a processor, memory and access to computer readable media, and a network 200 operatively coupled to the computer. The network may be the Internet, another computer network, a social network, or any means for interconnecting the present invention's computer 100 with merchants 300, a community of members 400, and products or services 500. The present invention further comprises a deal management component 600 operatively coupled to the present invention's computer 100 either directly or via a network 200. Referring now to FIG. 2, deal management component 600 further comprises 1.) a member module 610 configured to provide to the community of members 400 a way to communicate and interact using the network; 2.) a merchant module 620 configured to provide to a plurality of merchants 300 a way to receive aggregate purchase offers from the community of members; 3) a deal management module 630 configured to cooperatively provide aggregate purchase offers from the community of members 400 to a merchant 300 and to provide the merchant with a mechanism to accept, reject or counter the aggregate purchase offer; and 4.) a product management module 640 containing uploaded information related to a desired product or service 500 from a member of the community of members 400. Deal management component 600 also contains a mechanism for providing the community of members 400 with a way to accept, reject, or counter the aggregate purchase offer from the merchant 300, and a mechanism for providing the community of members with a way to split into two or more groups in order to treat a merchant's aggregate purchase offer in different ways, e.g., a plurality of members comprising one group choosing to accept the merchant's aggregate purchase offer, and the remaining members comprising a second group choosing to counter the merchant's offer.

The community of members may function on the basis of personal relationships established and managed via the present invention itself using member module 300, or in some embodiments, it may function through its members having joined one or more shared social networks (e.g., FACEBOOK™), or it may function as a feature or application of a specific social network or computer application (i.e., “there's an app for that”).

Other components, modules, interfaces, and functionality may further be included in the present invention and the various embodiments described or envisioned herein.

### Transaction Flow

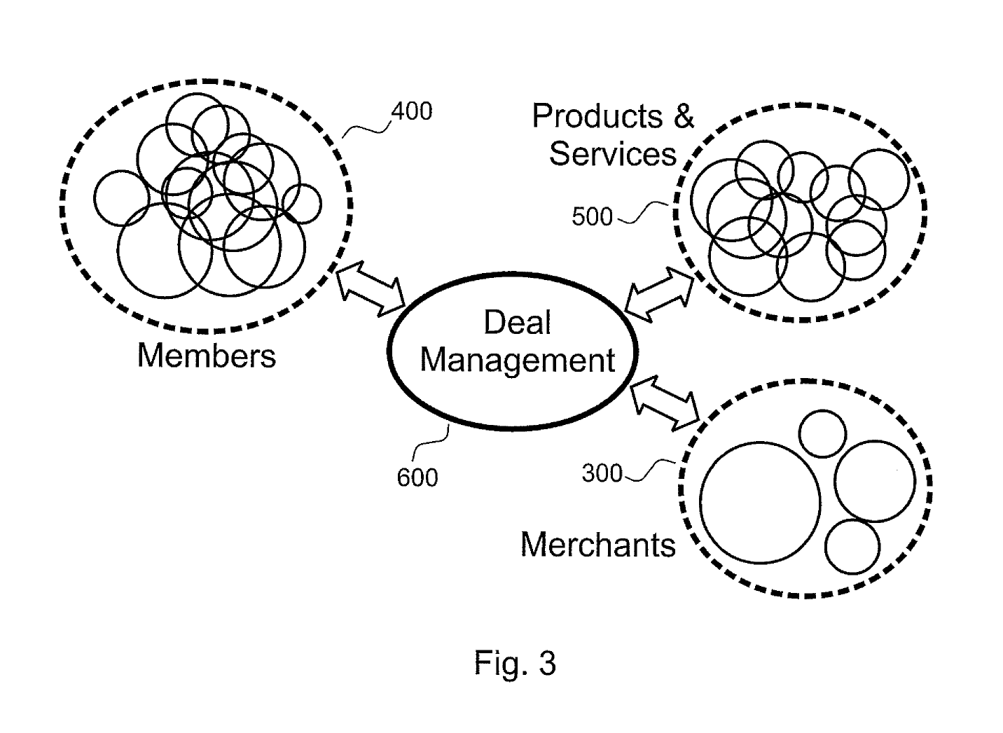

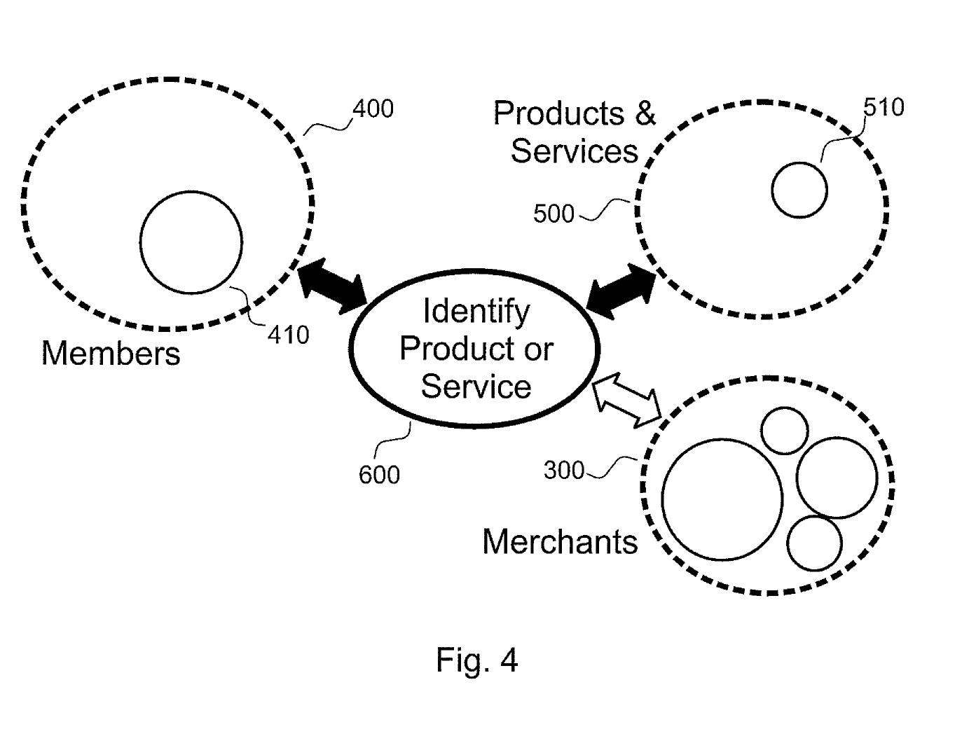

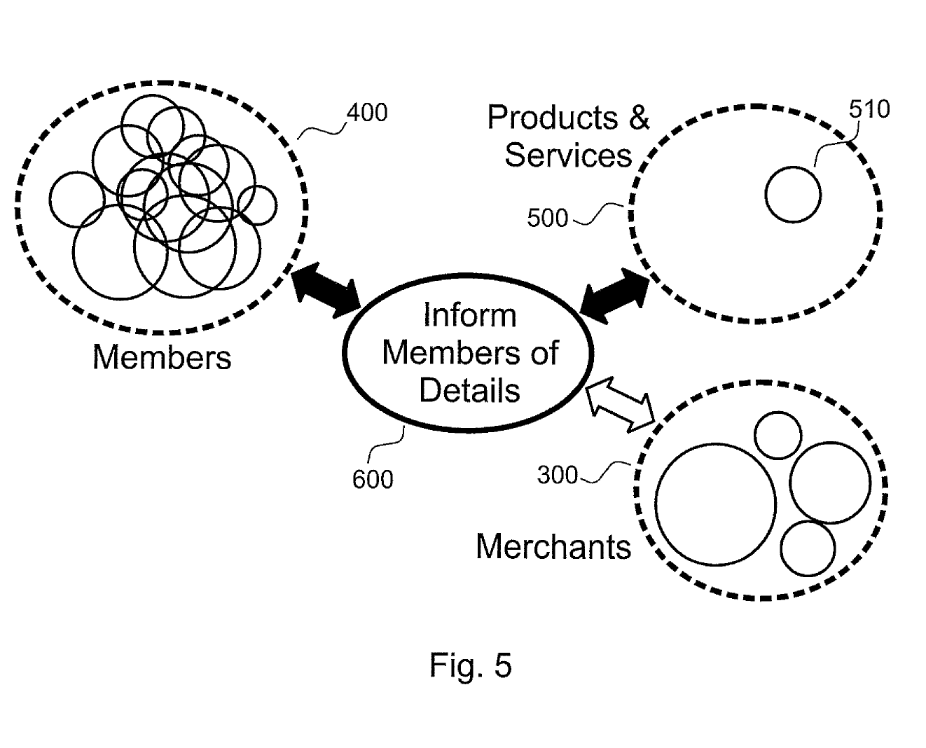

Referring again to FIG. 1, the overview of the flow of transactions in the present invention's processing is as follows. The present invention operates by creating on a computing device 100, a community of members 400 where the community of members 400 are connected by a network 200. In one embodiment of the present invention, the network is a social network 800 or has social networking components, functionality, or integration. The conceptual flow of the present invention's transactions is shown in FIGS. 3 through 8. Referring to FIG. 3, the initial state of the setting includes a community of members 400 having no specific deal or agreement, a group of merchants 300 with no specific deal-related connection to the community of members, and a set of products and services 500 not yet a part of any deal being processed by deal management component 600. As shown in FIG. 4, a member 410 in the community of members 400 identifies a product or service 510 for sale by one or more of the merchants 300 also connected by the network 200 (not shown in FIG. 4, see FIG. 1), and uploads information related to the desired product or service 500 to network 200, deal management module 600 (again, refer to FIG. 1), and computing device 100 (FIG. 1), thereby making the information related to the desired product or service 510 available to members of the community of members 400 based on conventional product and service search selection criteria as shown in FIG. 5.

Product and service selection criteria conventionally available for the community of members comprises historical buying preferences, member-specified buying preferences, geographic buying preferences (e.g., products and services preferred in a municipality or neighborhood), and demographic buying preferences (e.g., patterns of purchase correlating with disclosed patterns of language, ethnicity, age, or other population characteristics).

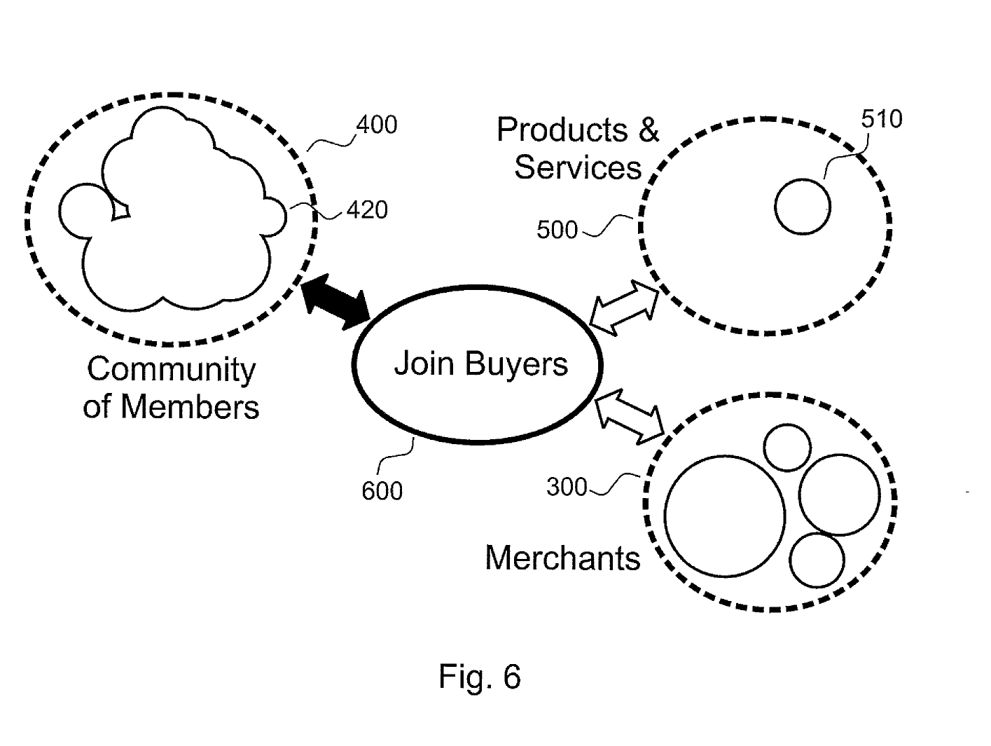

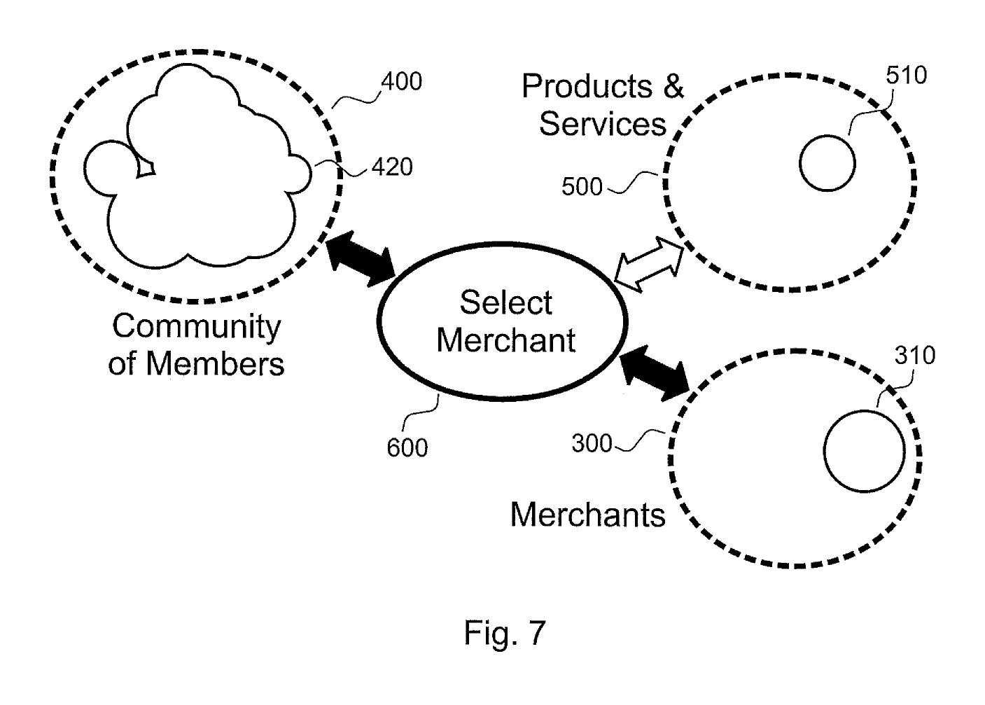

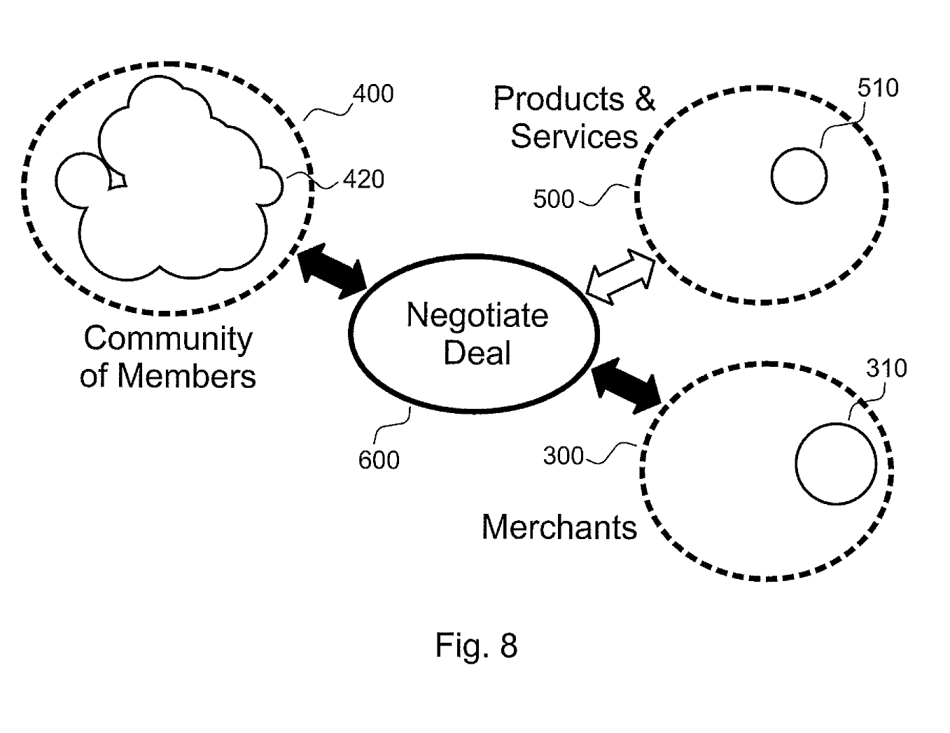

The present invention then aggregates purchase offers for the desired product or service 510 from members 420 of the community of members 400, as shown in FIG. 6, and a selection of a merchant 310 is provided, as shown in FIG. 7. The invention then transmits to the selected merchant 310 an aggregate purchase price and a quantity of purchase offers for the desired product or service 510 from members of the community of members 420, thereby initiating the detailed negotiation process as shown in FIG. 8.

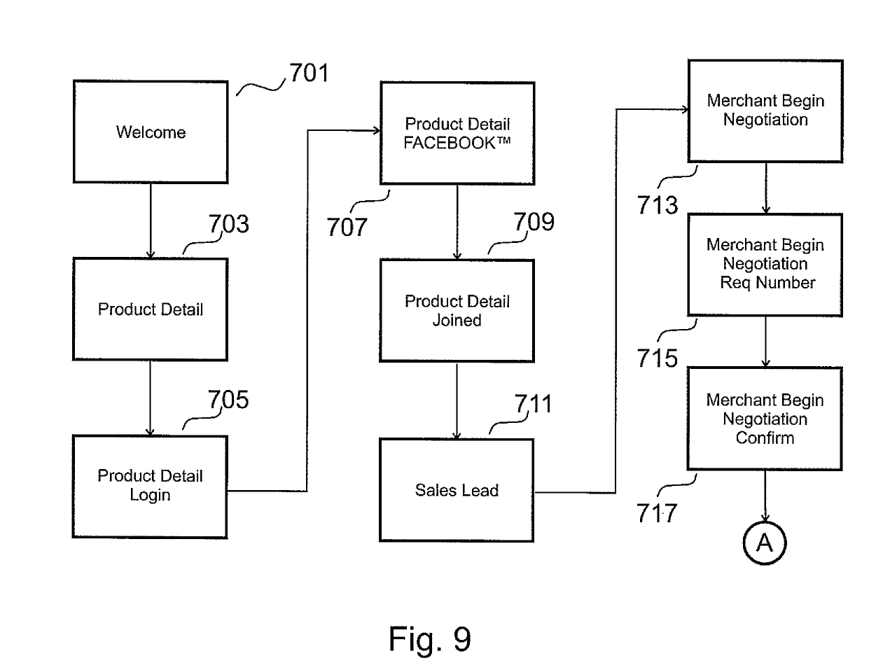

The process flow diagram of FIG. 9 summarizes the above stages of the invention's process up through the beginning of the detailed negotiation process. The welcome stage 701 presents a member of a community of members with an invitation to create a deal, or “Wink”.

The initiating member in the next stage 703 accepts product detail, additional members of the community of members log in at the next stage 705, review product detail at the next stage 707, and join the deal 709. The merchant targeted in the deal receives a sales lead 711 and begins negotiation 713, getting a negotiation request number 715 and a confirmation 717.

In the detailed negotiation process, the present invention transmits to the community of members either the merchant's acceptance of the aggregate purchase price or a counter-offer comprising a new purchase price set by the merchant. The present invention then transmits to the merchant either an acceptance of the counter-offer by members of the community of members or a new counter-offer to the merchant by members of the community of members. Finally, in the case of the new counter-offer by members of the community of members, the invention transmits to the community of members the merchant's acceptance or rejection of the new counter-offer.

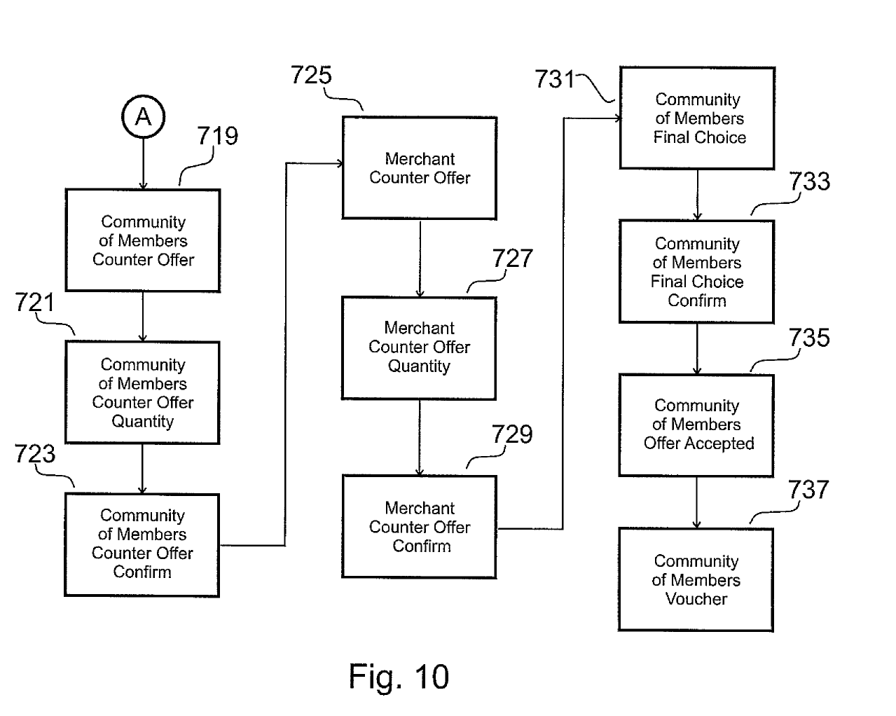

The process flow diagram of FIG. 10 summarizes the steps of the detailed negotiation process itself. Once the merchant has made an offer, the members in the community of members who are in the deal may counter the offer (steps 719, 721, 723). The merchant may then respond with a counter offer (steps 725, 727, 729). To close the deal, the community members make a final choice (steps 731, 733), and on acceptance (step 735) each member in the deal receives a voucher (step 737).

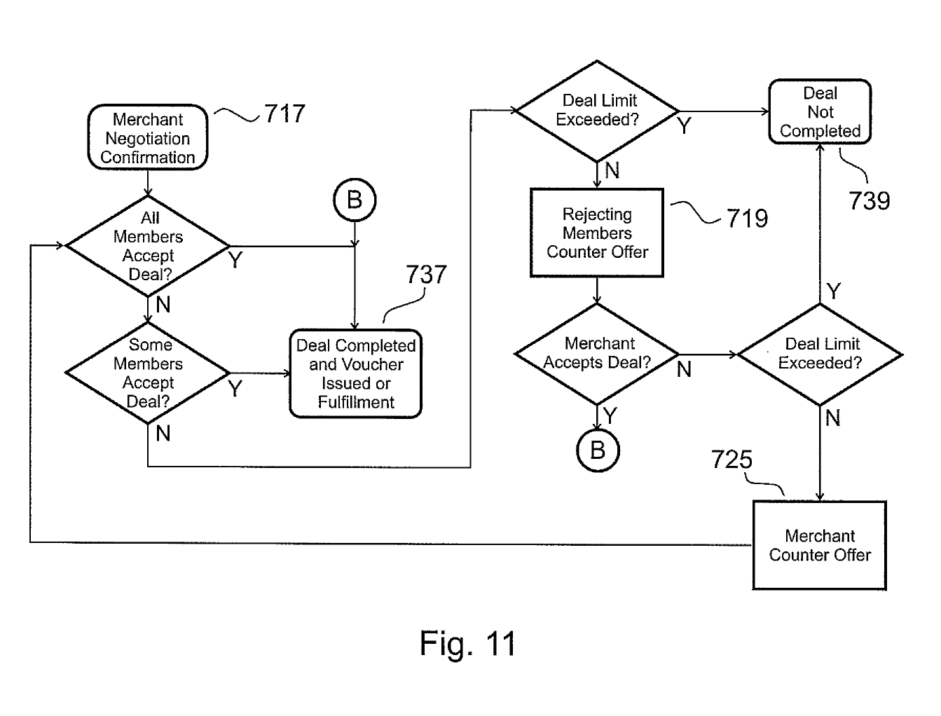

The present invention's negotiation process is detailed in FIG. 11. Once the merchant has confirmed the start of negotiation 717, the members choose whether or not to accept the deal. If all members accept the deal, the deal is completed and a voucher is issued 737. If some or all members do not accept the deal and the number of counter offers they can submit is exceeded, the deal is not completed 739. If some or all members do not accept the deal and the number of counter offers they can submit is not exceeded, the members issue a counter offer 719 to the merchant. If the merchant accepts the deal, the deal is completed and a voucher is issued 737. If the merchant does not accept the deal and the number of counter offers the merchant can submit is exceeded, the deal is not completed 739. If the merchant does not accept the deal and the number of counter offers the merchant can submit is not exceeded, the merchant issues a counter offer 725 to the members, and the process repeats a number of times according to the configuration of the present invention.

### Comprehensive Description

The present invention operates through a conventional internet (or similar network) interface using a browser program's screens and forms. The present invention's member module provides a member of a community of members the screens to identify a desired product or service. “Product” or “service” is also referred to herein as “item”.

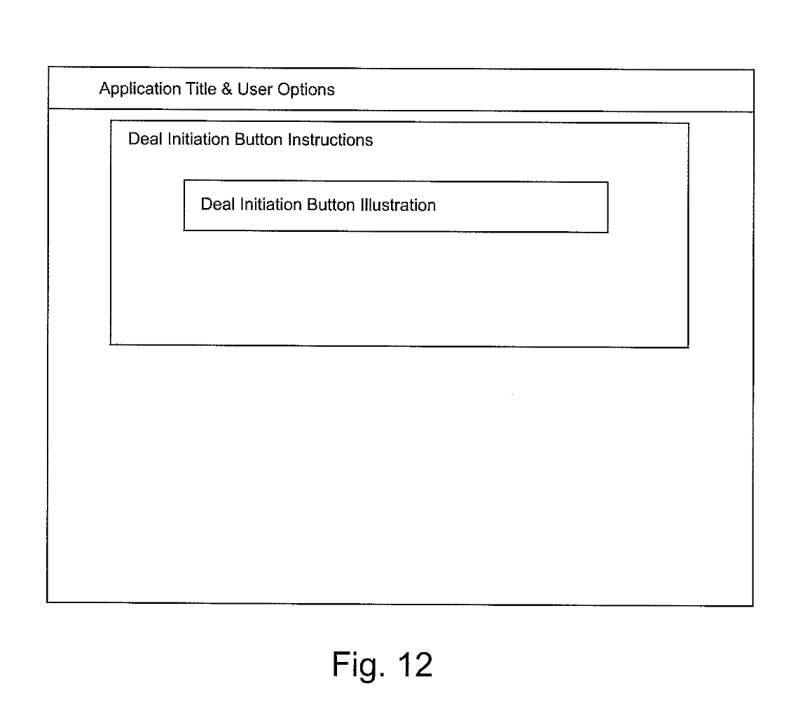

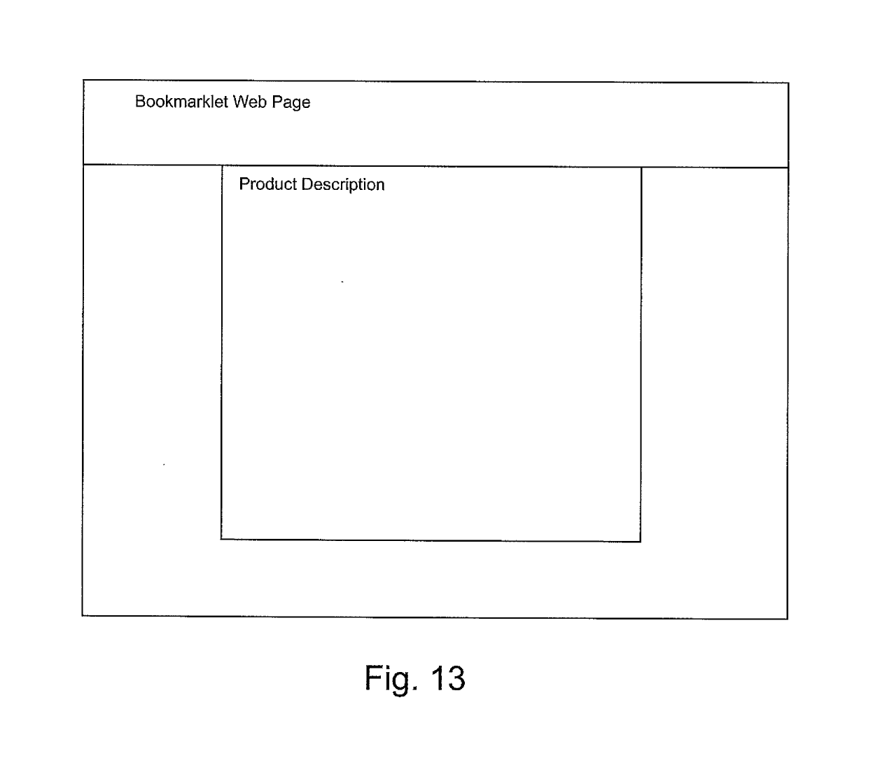

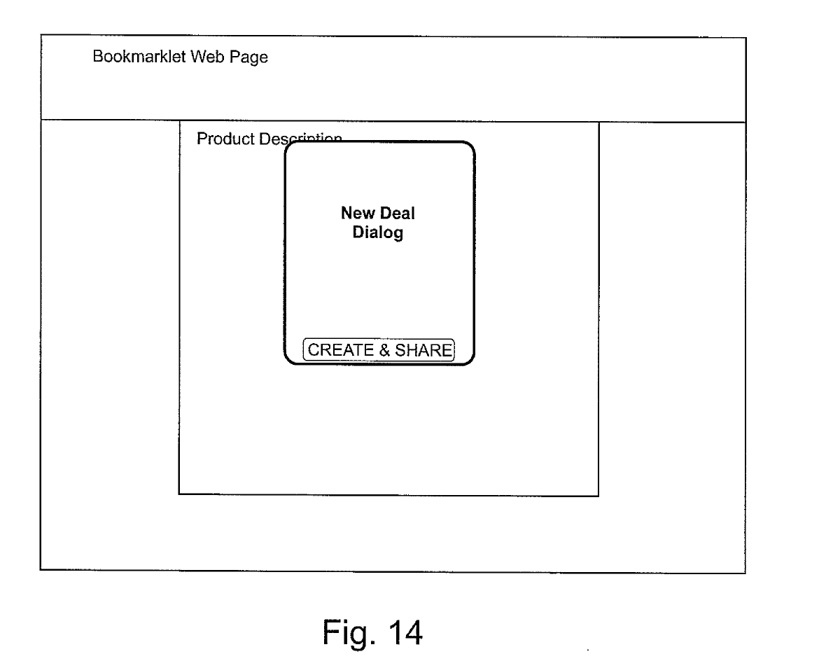

The functions of the present invention apart from the detailed negotiation process may take place in many different orderings dependent on the events initiated by members, members who have joined a deal, and merchants. For this reason the following description of the present invention's system and process as shown in FIGS. 9 and 10 cannot be taken as comprising a strictly-ordered series of steps. By contrast, the detailed negotiation process that began when a merchant responds to a deal proposed by one or more members follows a sequence of conditional steps as shown by way of example in FIG. 11. A merchant (i.e., potential seller) or a member (i.e., potential buyer) first gains deal-making access to the present invention in one example by installing a browser button for defining potential deals as shown in FIG. 12. The merchant or member then selects items as candidates for the invention's process using the merchant Web pages as shown in FIG. 13. If an item found on the merchant Web pages appears suitable for a deal, the merchant or member initiates a dialog for creating a new deal as shown in FIG. 14, in which the merchant, the item, and the initial price are identified. Once the deal is created, the present invention circulates it by posting it on the merchant's pages as presented by the present invention. By uploading information related to the desired product or service to a network, the present invention makes available to the members of the community of members information concerning both the product and the merchant offering that product.

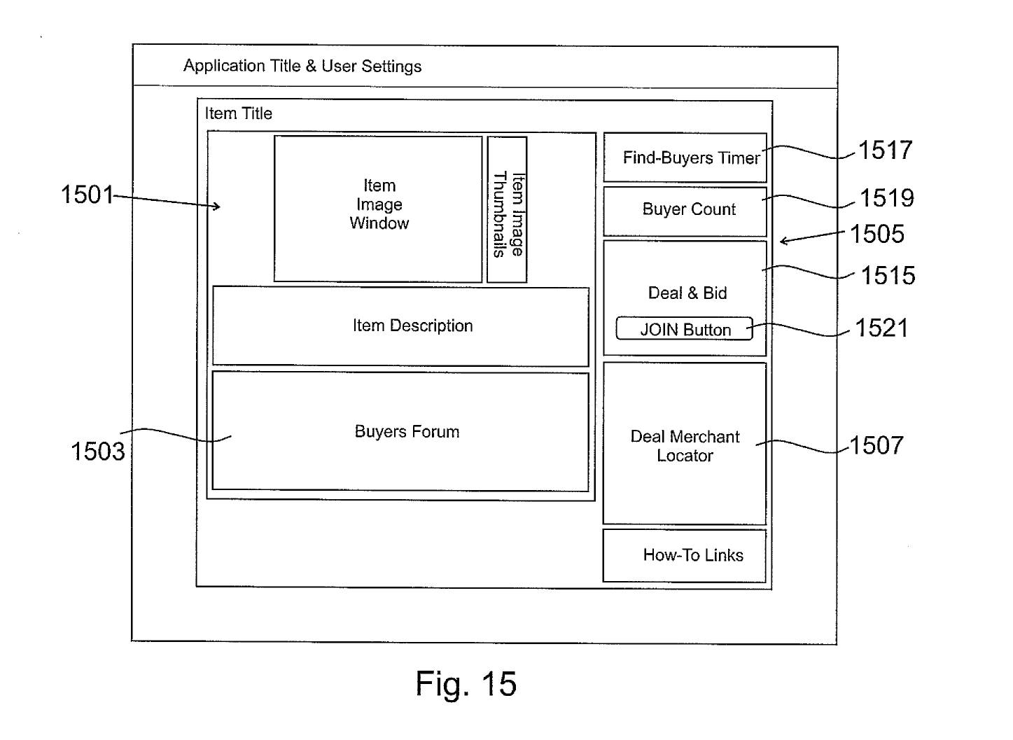

The information providing the product or service detail display for a deal is shown in FIG. 15, including product or service information 1501, a buyers forum 1503, a deal status display 1505, and a mini-map 1507 showing the merchant location.

The product information 1501 representing the desired product or service includes a picture or image, a description, a price, and information concerning the merchant making the product or service available for purchase.

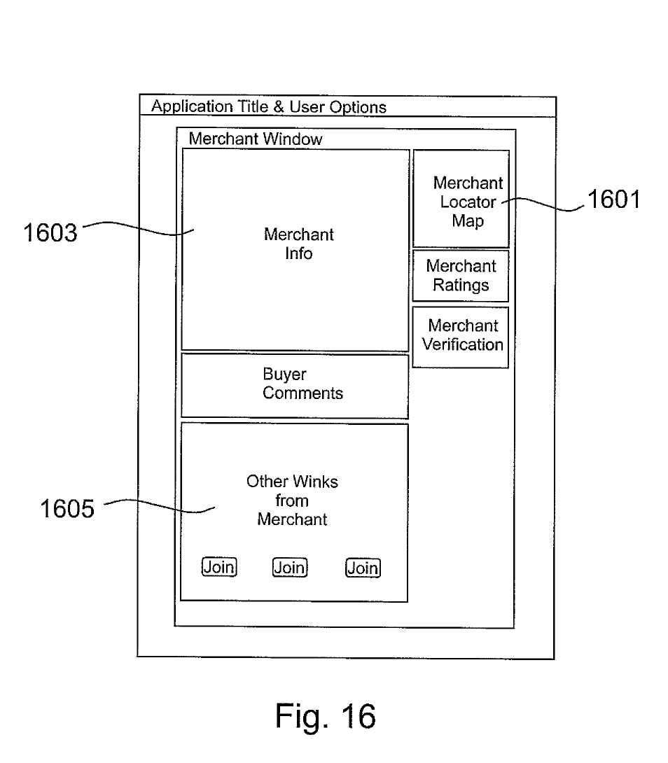

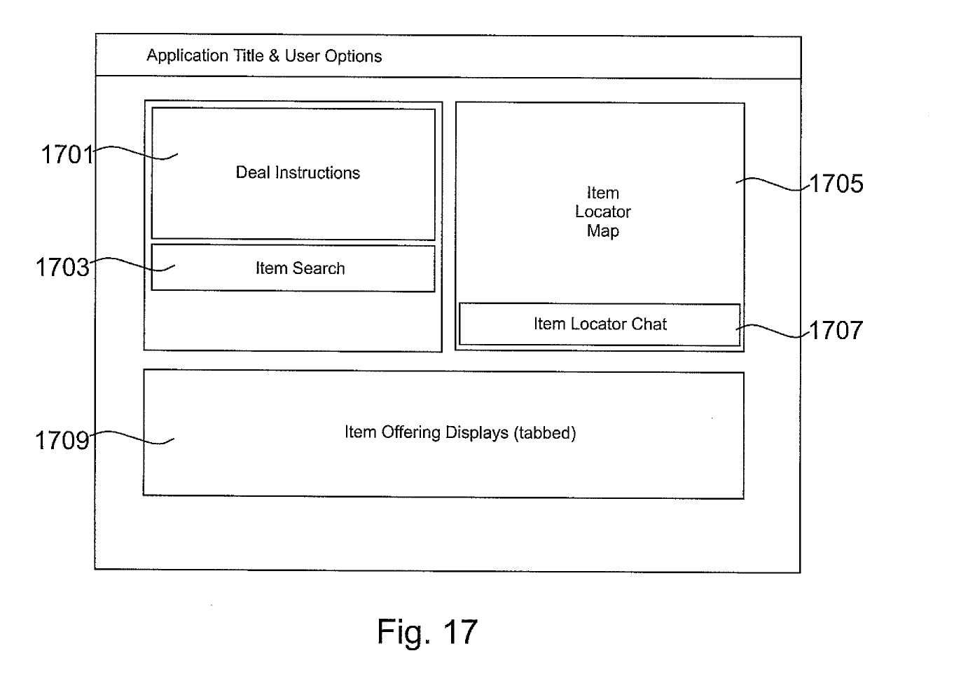

To the advantage of a merchant participating in a deal, the present invention provides a merchant detail display as shown in FIG. 16 that shows not only merchant location 1601 and information 1603 but also existing deals 1605 offered by that merchant using the present invention. The opening stage of the present invention's operation for the community of members is shown in the welcome display of FIG. 17, which invites a member to search out and propose a deal for other members to join. FIG. 17 offers instructions 1701 for making a deal, an item search entry space 1703, an item locator map 1705 for places to purchase the item, an item locator chat window 1707 for members to share information, and an item offering display 1709 for different items available for deals.

A deal using the present invention can be created for almost any kind of product or service, such as a coffee maker, a handbag, a virtual garage sale, or a sharing of snow removal services.

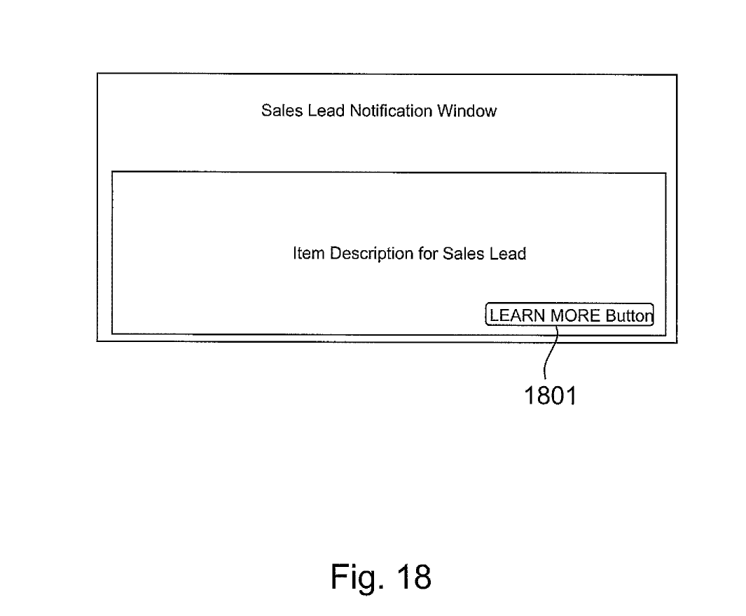

When a number of members have joined a possible deal for a product or service, the present invention informs the merchant by presenting the merchant with a sales lead notification as shown in FIG. 18. The merchant begins engagement in a deal by selecting the LEARN MORE button 1801.

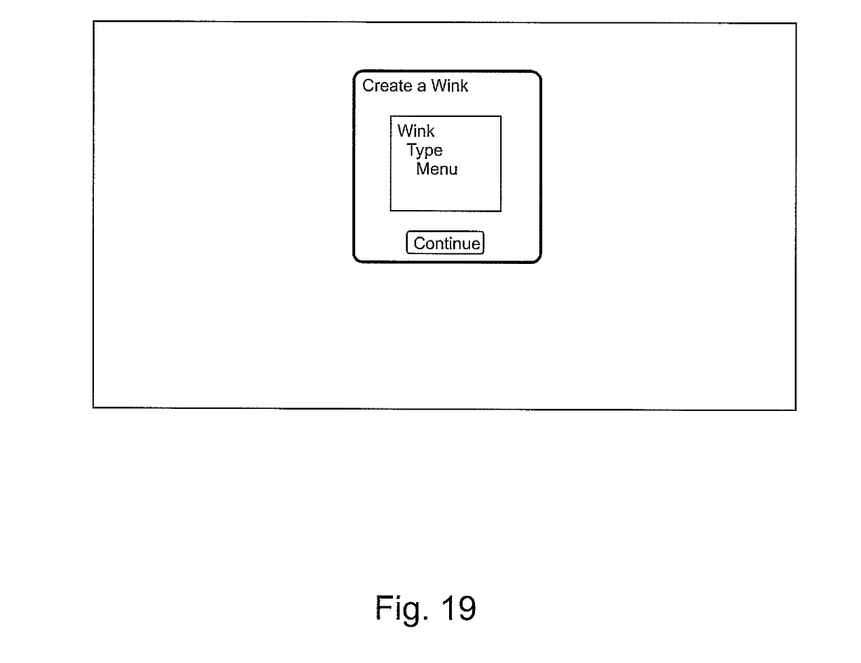

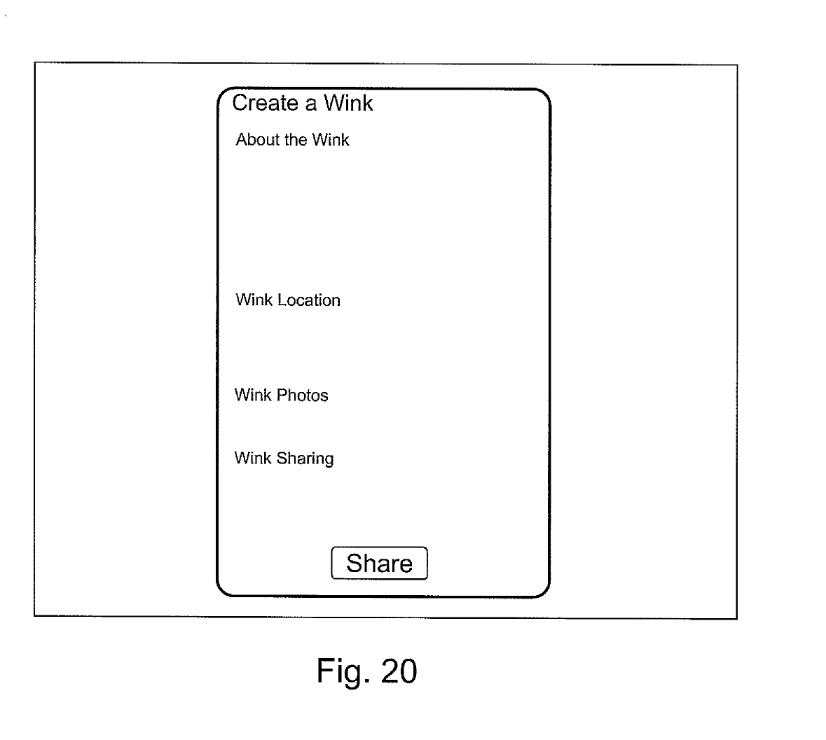

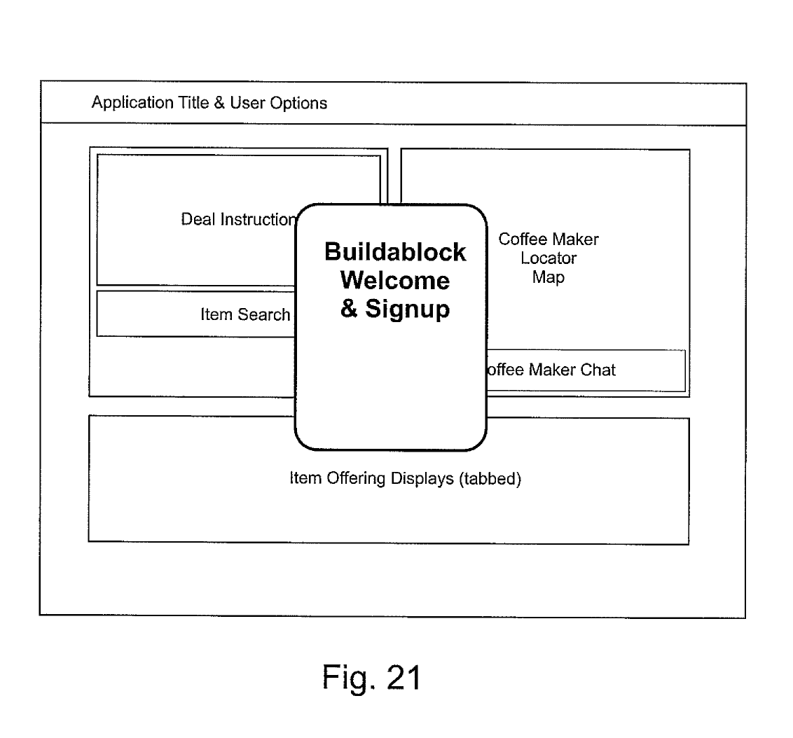

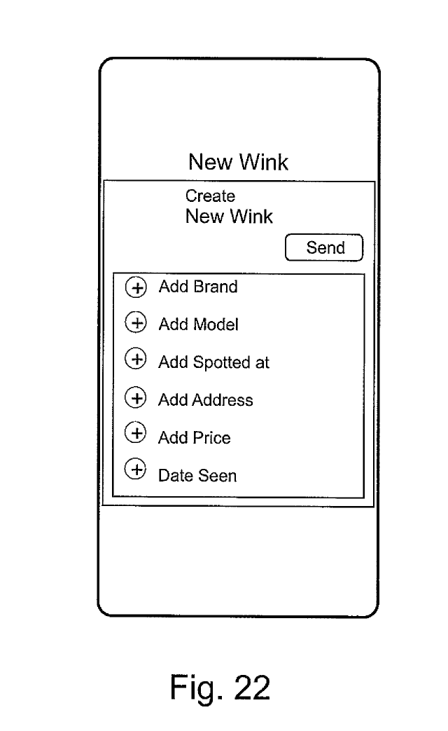

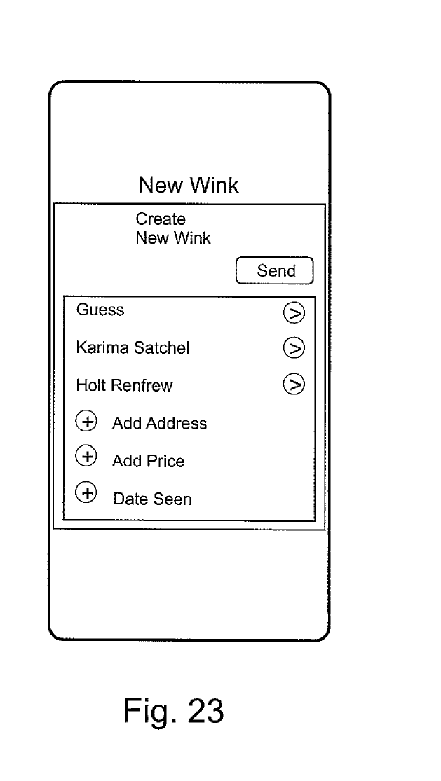

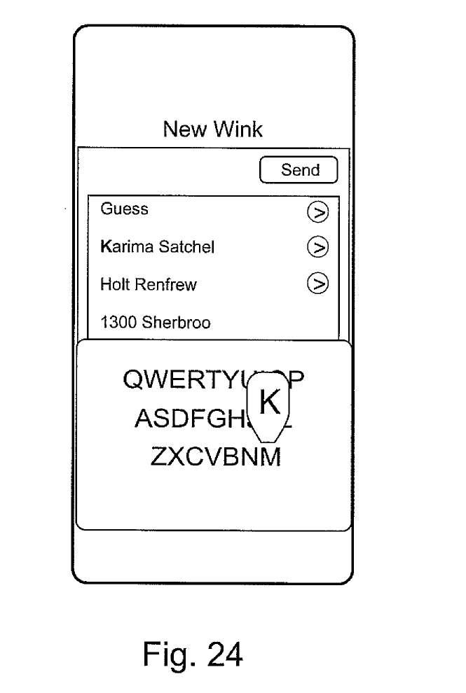

The present invention provides alternative pathways for setting up a deal. A member who is a user of social media, e.g., FACEBOOK™, can create a deal using his or her account in conjunction with the invention's social networking components, as shown in FIGS. 19, 20, and 21. Other social media, e.g., TWITTER™, can be employed in the same fashion. A user of a phone or similar portable electronic device equipped with graphical online applications can likewise create a deal using the phone app provided by the present invention, as shown in FIGS. 22, 23, and 24.

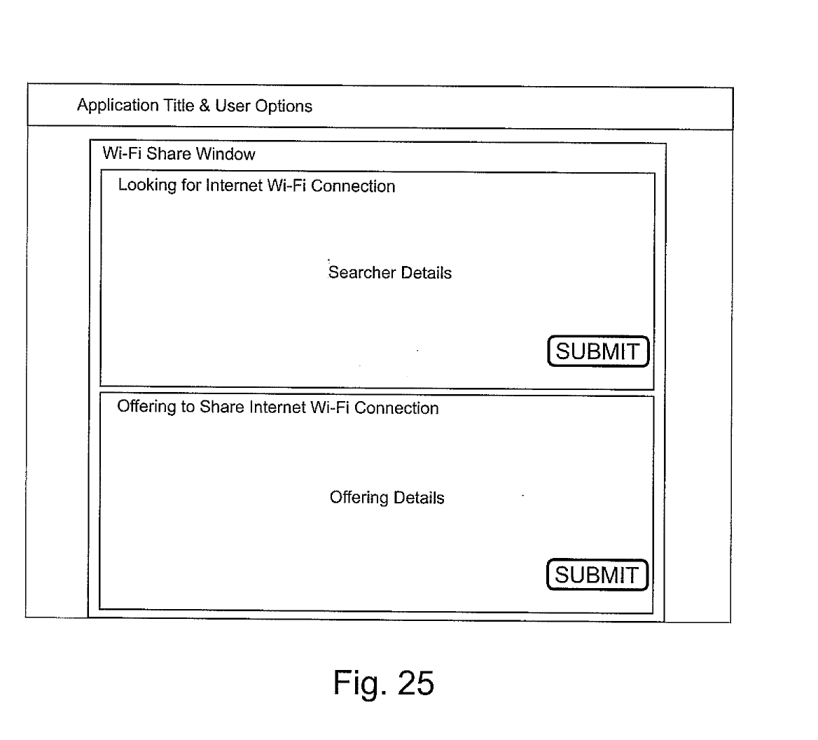

The present invention's range of potential deals encompasses a wide variety of products and services, e.g., coffee makers, handbags, WiFi sharing, virtual garage sales, sharing of snow removal, and sharing of WiFi services, any of which may motivate sharing activity. The invention's service sharing provides both for those offering to share and for those seeking sharing, as seen in FIG. 25.

The invention's item detail display as shown in FIG. 15 contains rich detail, including item information 1501, merchant location and merchant information 1507, any existing deal 1515 engaged by that merchant for the item using the present invention, and a buyer's forum 1503 for members already involved in the existing deal. The present invention further displays deal status 1515 breakdown comprising the list price, the opening bid, the time left for the deal before expiration 1517, the number of buyers engaged so far in the deal 1519, and the number of buyers still needed to close the deal. The present invention further provides a JOIN button 1521 for a member viewing the deal to join the deal.

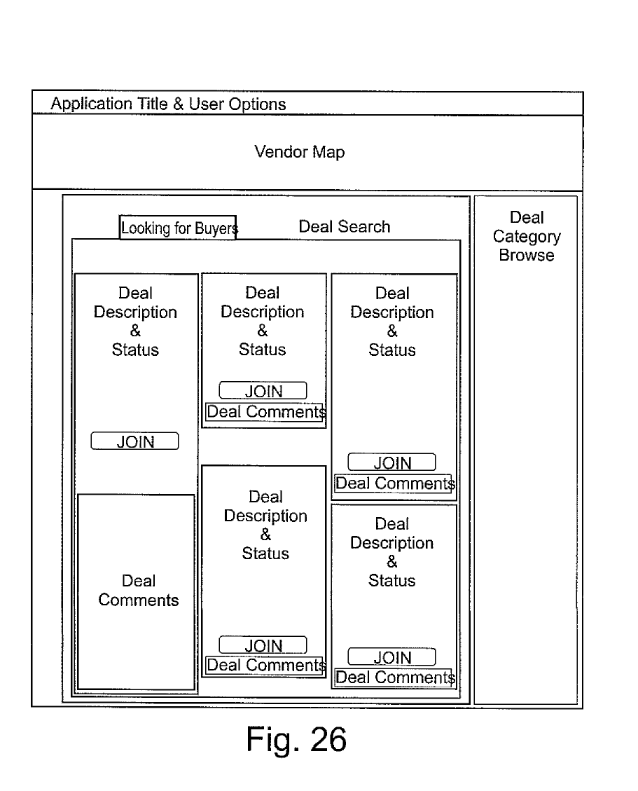

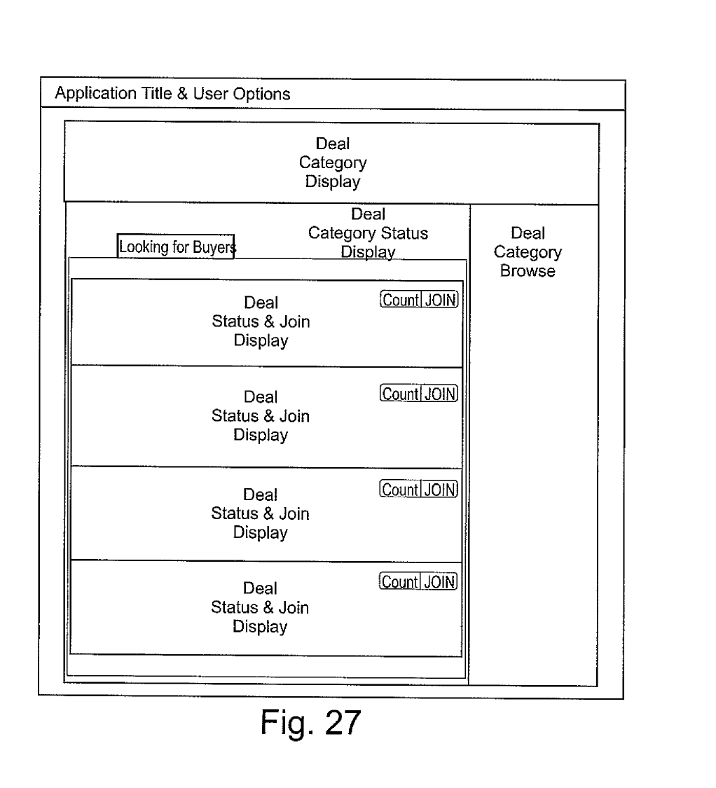

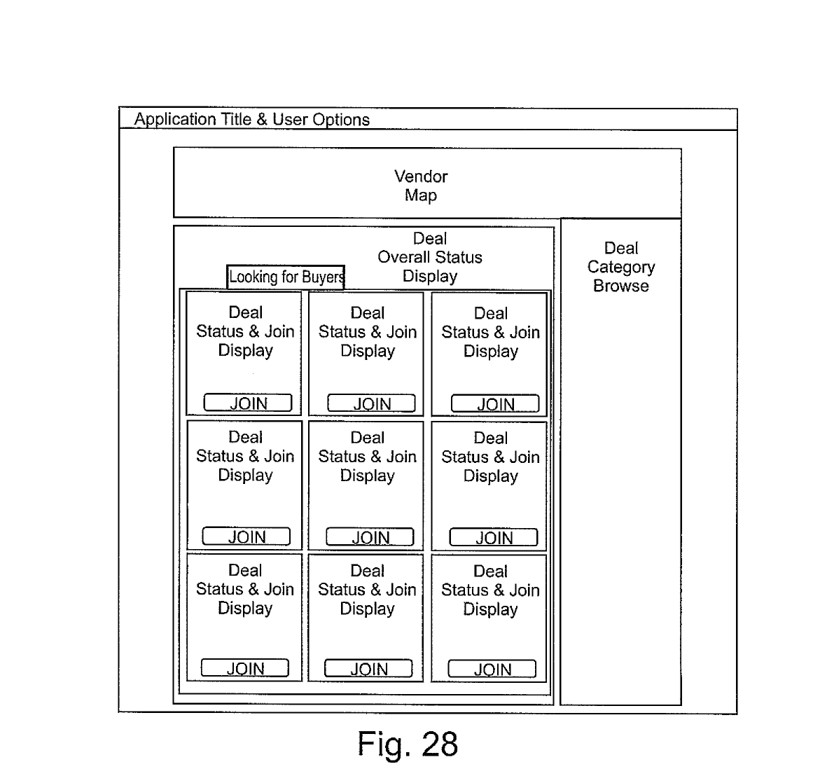

The present invention makes deal information related to desired products or services available to members of the community of members based on selection criteria as shown in FIGS. 26, 27, and 28 for a single merchant. FIG. 26 shows a display of the merchant's deals in all product and service categories, accompanied by comments from prospective and participating deal members. FIG. 27 shows a display of the merchant's deals for a single product or service category. FIG. 28 shows a display of the merchant's deals in all product and service categories with each deal presented in an abbreviated form. All three displays include each deal's status, deal status comprising the list price, the opening bid, the time left for the deal before expiration, the number of buyers engaged so far in the deal, and the number of buyers still needed to close the deal.

Via the deal-offering screens shown in FIGS. 26, 27, and 28, the present invention aggregates purchase offers for the desired product or service from participating members of the community of members, adding members to deals to meet the number of buyers needed in each deal. When a specified buyer threshold for a particular deal is reached, the detailed negotiation process can begin for that deal. The present invention uses the aggregate purchase offers from participating members to calculate an aggregate purchase price to convey to the merchant. The present invention in some embodiments calculates the aggregate purchase price as an average value of the offers tendered by the participating members. An average value may be calculated as a mean value, a median value, or a modal value. The present invention in other embodiments calculates the aggregate purchase price using other methods, e.g., highest or lowest value offered, or some other value computed using other methods.

The present invention may maintain historical information concerning merchant preferences and patterns, and may apply said information in calculating aggregate purchase prices in later deals.

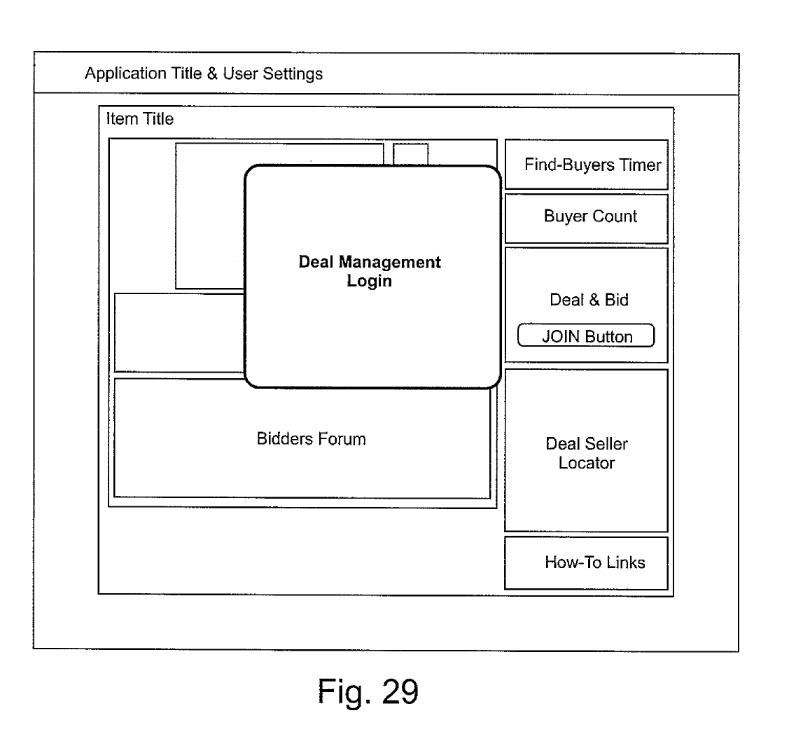

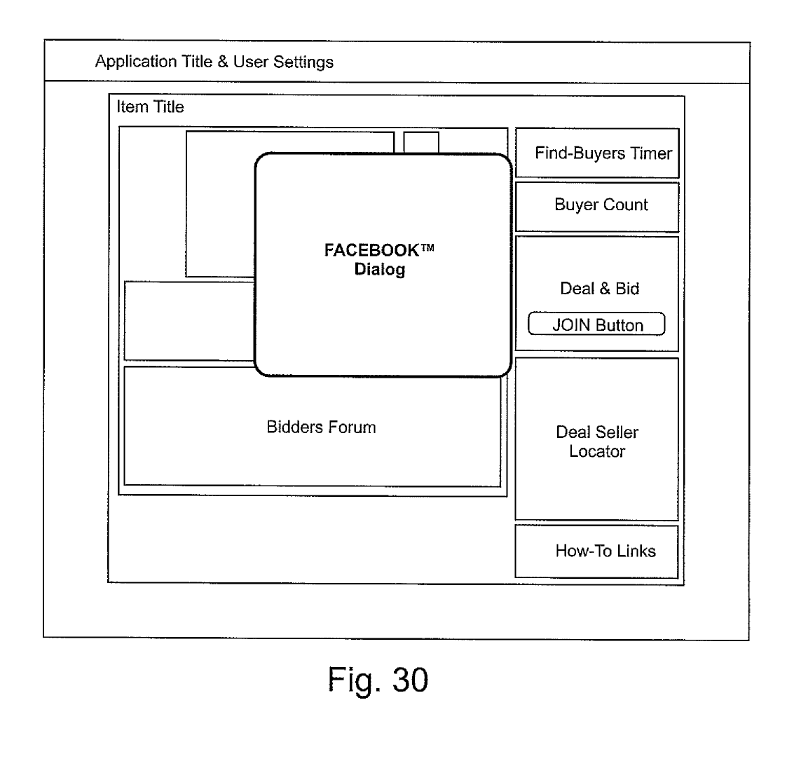

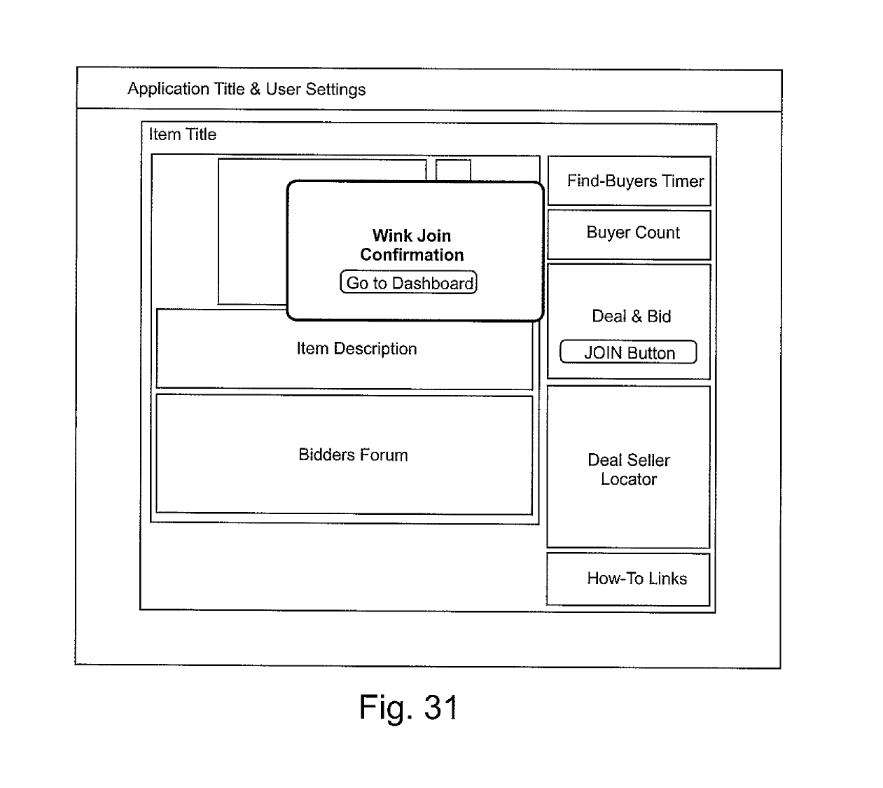

The present invention's member aggregation process operates as follows. The member logs into the system of the present invention via a conventional electronic mail login process or a social media login process as in, for example, FACEBOOK™, as shown in FIG. 29. Any social media login process takes place according to the specific application's requirements, shown here by example, and not limitation, for FACEBOOK™ in FIG. 30. The member joining a deal receives from the present invention's deal management module a join confirmation as shown in FIG. 31.

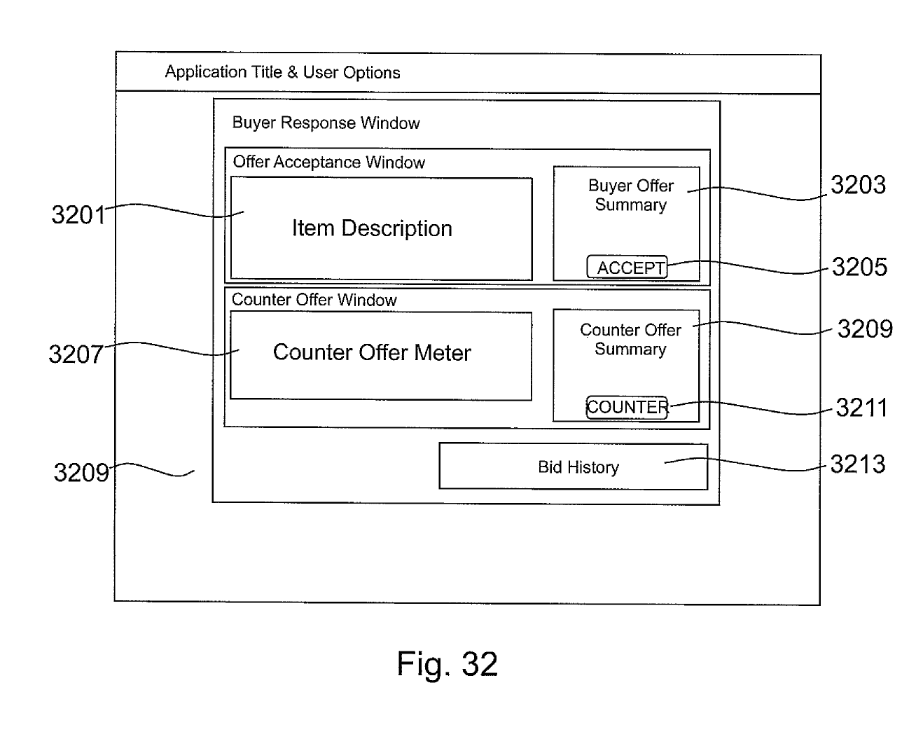

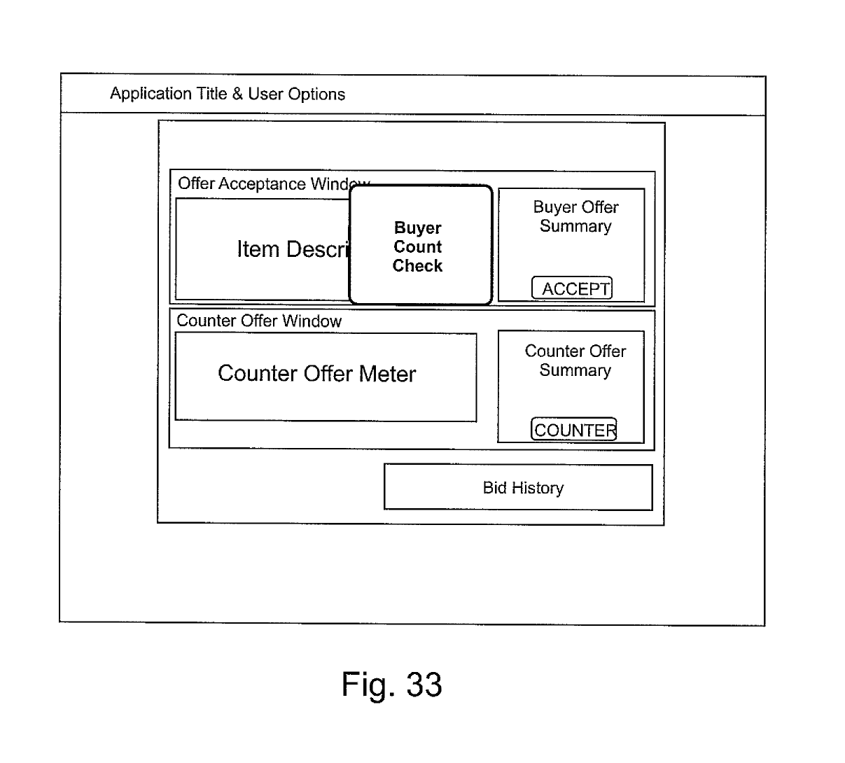

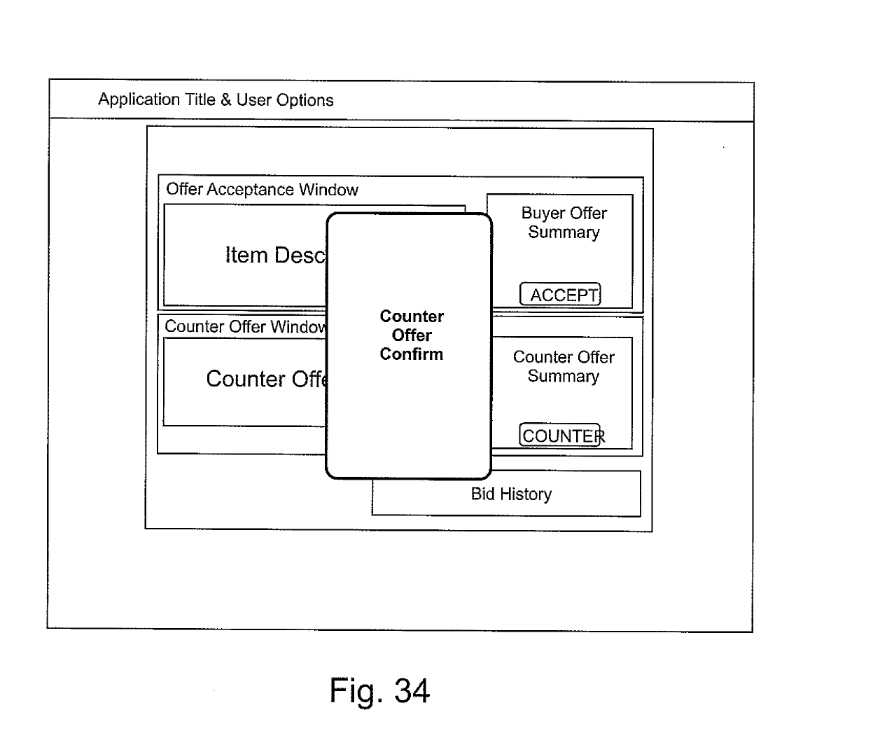

The present invention transmits to the deal's merchant an aggregate purchase price and a quantity of purchase offers from members of the community of members, as shown in FIG. 32, which shows an item display 3201, a buyer offer summary 3203, an acceptance button 3205, a counter offer meter 3207 for re-pricing, a counter offer summary 3209, a counter offer button 3211 and a bid history 3213. The page shown in FIG. 32 thus provides a mechanism for the merchant to adjust the minimum and maximum numbers of buyers and either accept the aggregate purchase price or to provide a counter-offer comprising a new purchase price. If the merchant is making a counter offer, the merchant confirms the buyer count as shown in FIG. 33 and the counter offer as shown in FIG. 34.

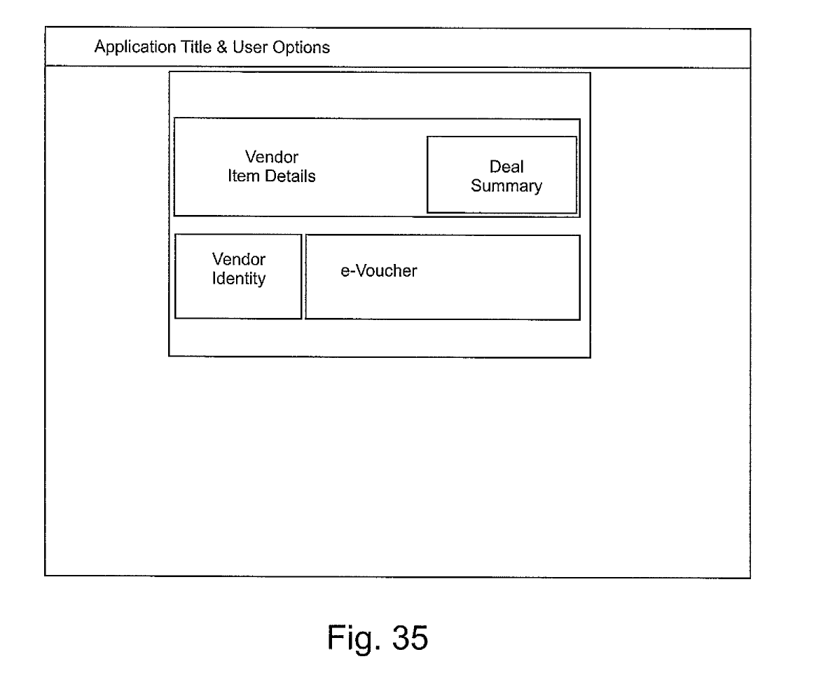

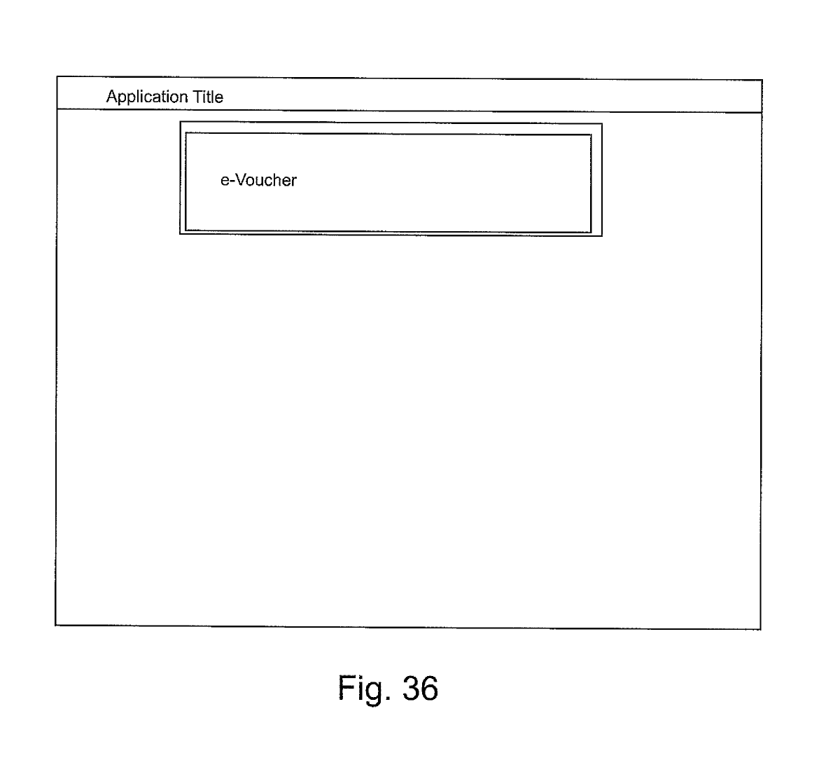

If the merchant accepts the deal offered by the members, a notification of acceptance is sent to the members as shown in FIG. 35, and a voucher is sent to the members as shown in FIG. 36 for use in completing the negotiated transaction.

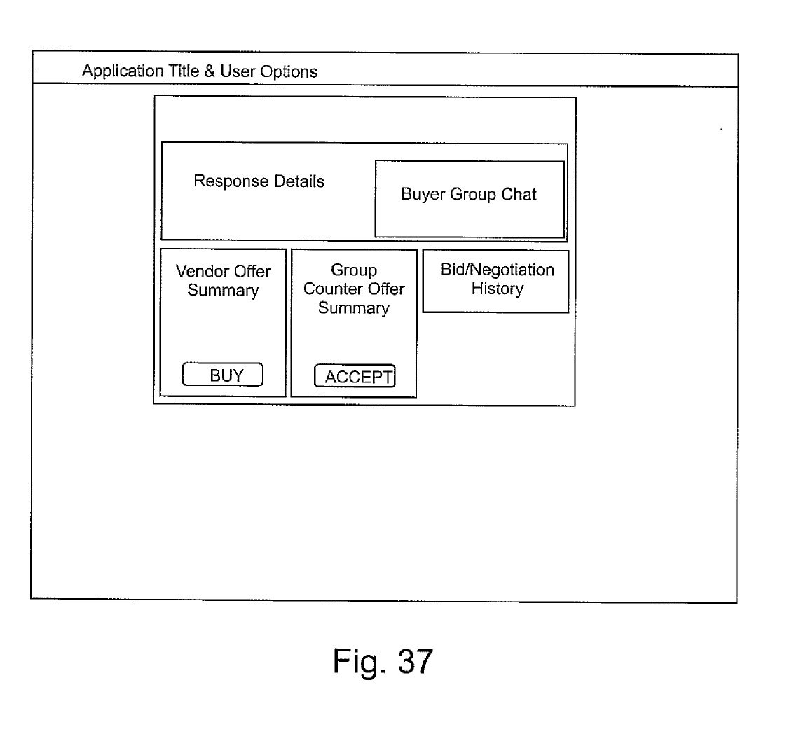

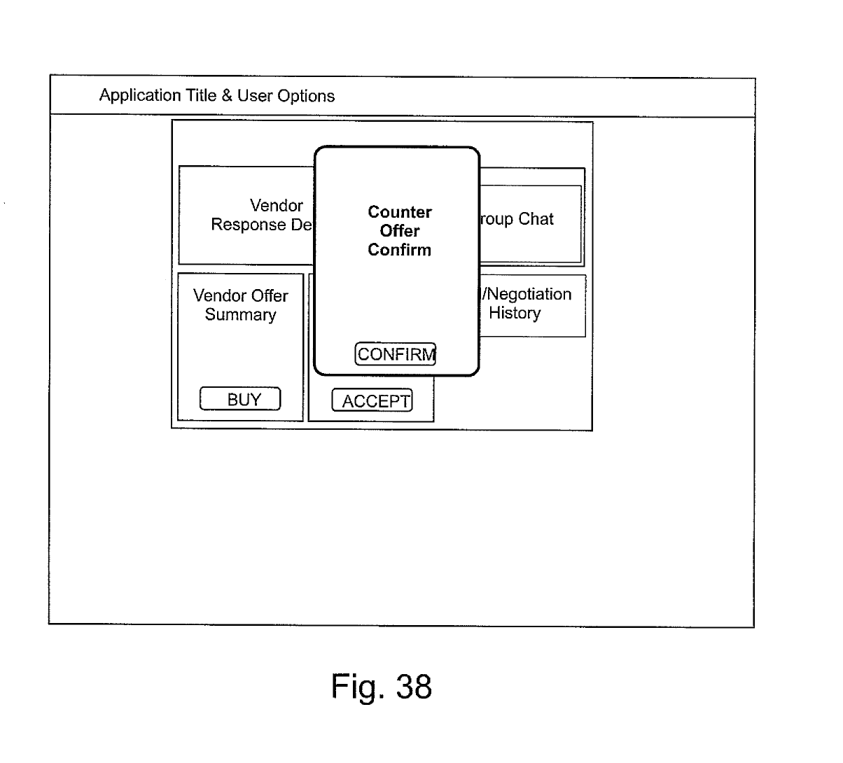

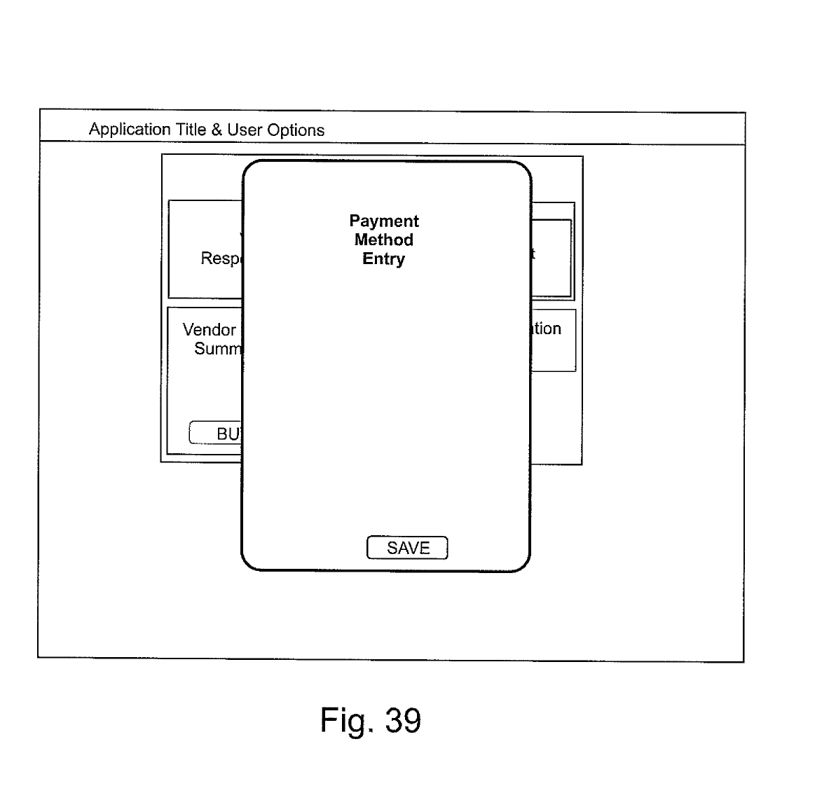

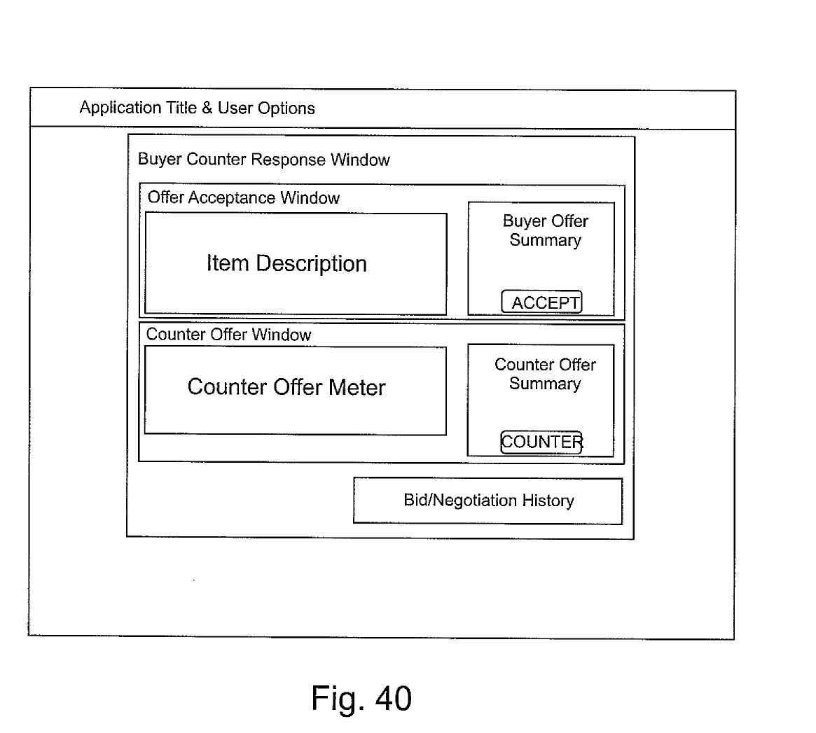

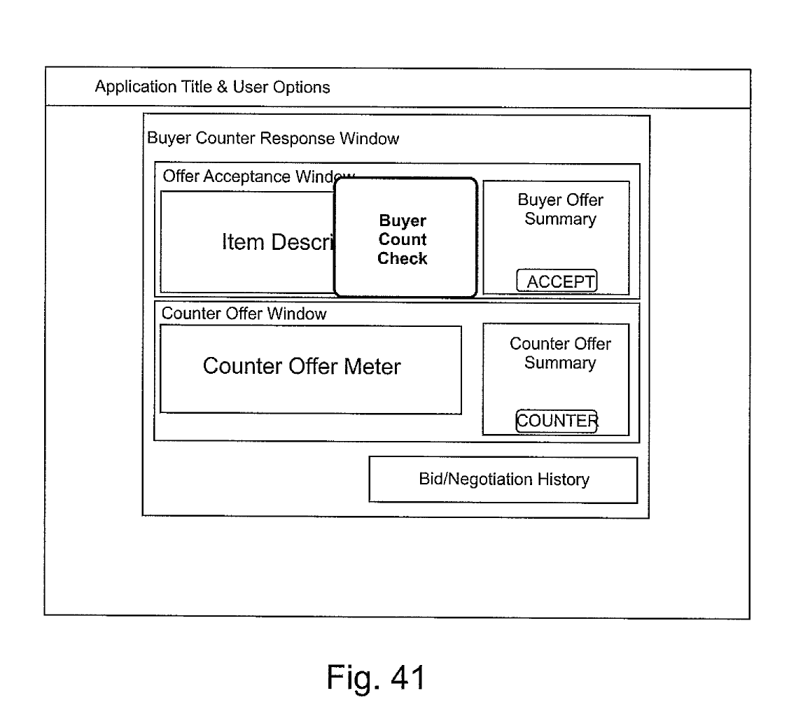

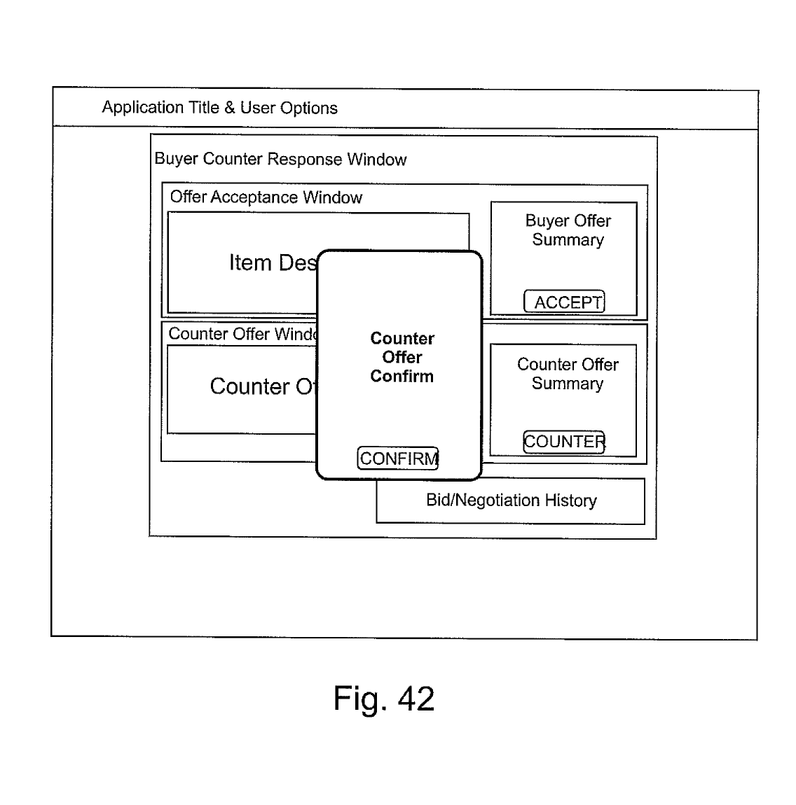

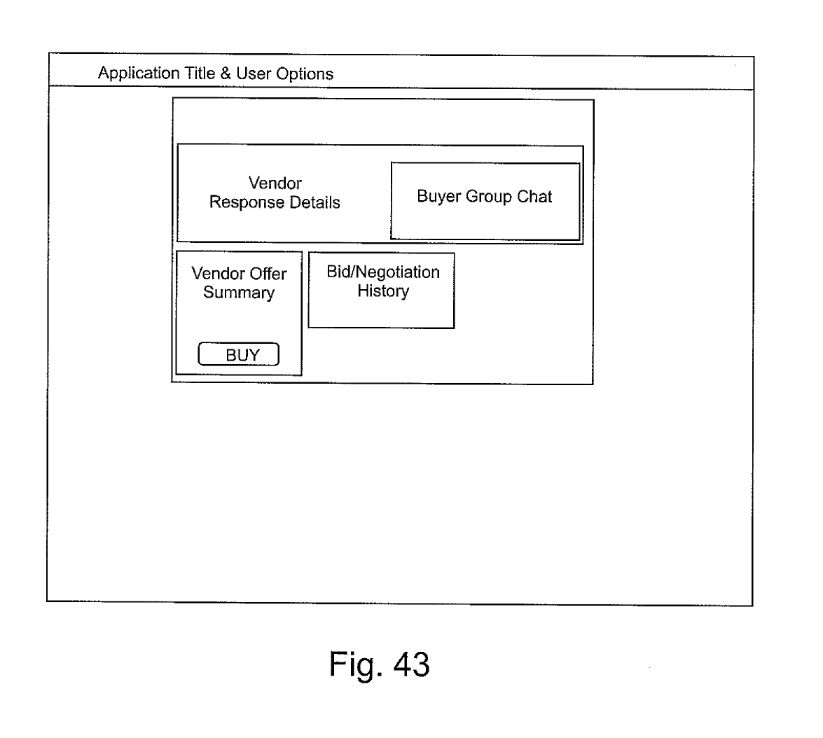

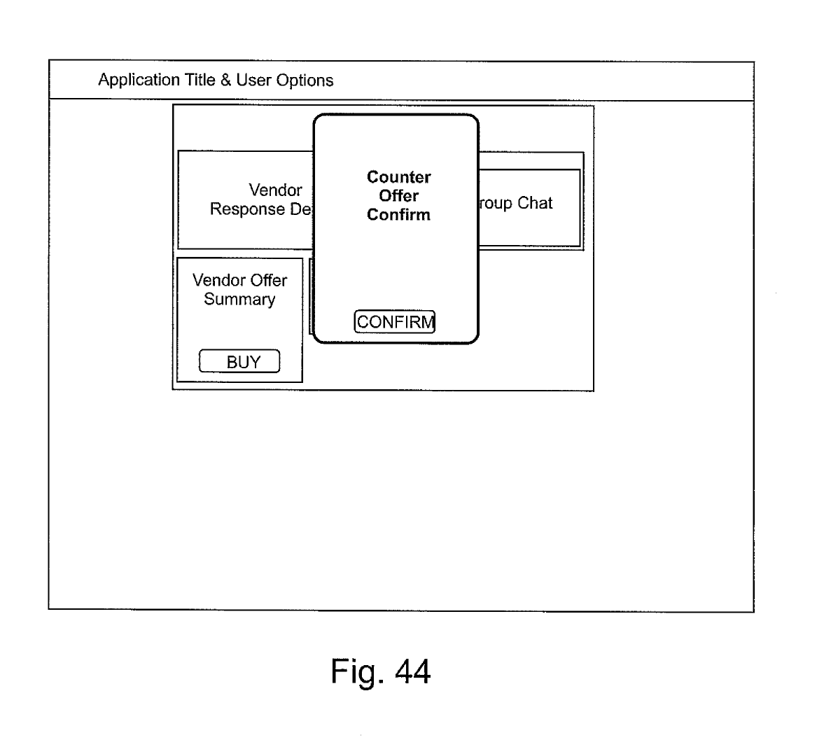

If the merchant is making a counter offer, the present invention provides for members of the community of members to either accept the counter-offer, as shown in FIGS. 37, 38, and 39, or to provide a new counter-offer to the merchant, as shown in FIG. 40. Some or all members may accept the merchant's counter offer, in which case they are sent a notification of acceptance and a voucher as described above. Other members may decide to provide a new counter offer similar to the initial offer, as illustrated in FIGS. 41, 42, 43, and 44.

If the merchant accepts the counter offer deal presented by the members, a notification of acceptance is sent to the members as shown in FIG. 35, and a voucher is sent to the members as shown in FIG. 36 for use in completing the negotiated transaction.

In one embodiment of the invention, if the merchant rejects the counter offer deal, the transaction is terminated. In embodiments providing additional iterations of negotiation, the merchant and members may provide further counter offers to some higher limit of iterations.

### Member Status

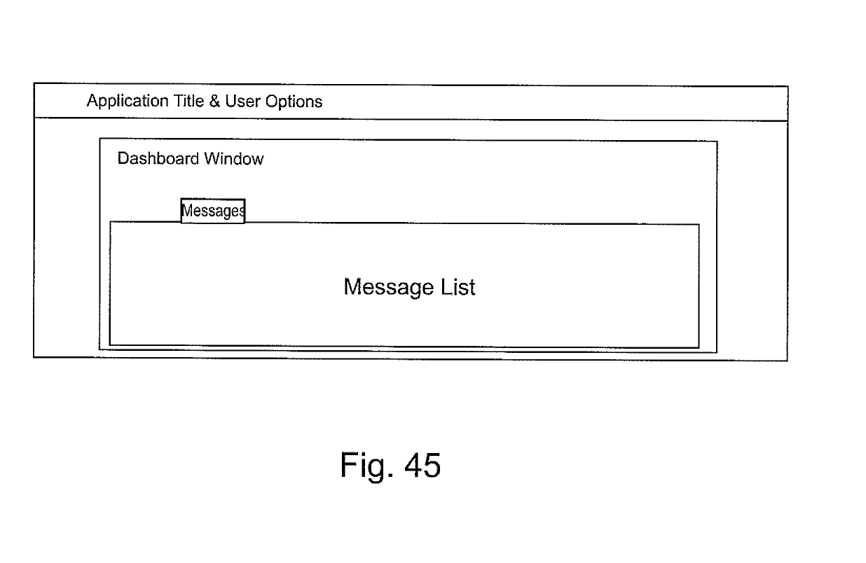

The present invention provides an interface (a member ‘dashboard’) for members to maintain and access relevant information, as shown in FIGS. 45 (member message list), 46 (member deals in progress), 47 (member profile information), 48 (user settings), and 49 (member voucher list).

### TERMINOLOGY

To clarify usage of various terms in this specification, the following equivalences of terminology are provided. The figures may reflect either the terminology of the invention as developed, or the conventional terminology with which each such term is associated.

Boolmarklet: small program contained in a bookmark
Buildablock: deal management
Dashboard: member status
New Wink: new deal proposal
Wink: deal proposal
Wink It: deal initiation
buyer: member (or consumer)
item: product or service
seller: merchant
shopper: member
user: member
vendor: merchant
Some terms are generic descriptive identifiers used in exemplary screen figures, and said generic identifiers correspond to invention-distinctive identifiers as follows:
Application Title & User Options (used at the top of the screen): Buildablock/Login/Sign Up/Connect with FACEBOOK™/Create a Wink
Deal Initiation: “Wink It”
New Deal: New Wink

### SUMMARY

It is, therefore, apparent that there has been provided, in accordance with the various objects of the present invention, a system and method for identifying and purchasing retail products. The system and method of the present invention includes, in some embodiments, social networking and social media components, integration, interfaces, and the like.

While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of this specification, claims, and the attached drawings.

What is claimed is:

1. A computer-based system for identifying and purchasing retail products comprising:
a computer having a processor, memory and access to computer readable media;
a network operatively coupled to the computer;
a user module stored on the computer readable media and configured to provide to a community of members a way to communicate and interact using the network;
a vendor module stored on the computer readable media and configured to provide to a plurality of vendors a way to receive aggregate purchase offers from the community of members;
a deal management module stored on the computer readable media and configured to cooperatively provide aggregate purchase offers from the community of members to a merchant and to provide the merchant with a mechanism to accept, reject or counter the aggregate purchase offer; and
a product management module stored on the computer readable media and containing uploaded information related to a desired product or service from a member of the community of members.

2. The system of claim 1, wherein the deal management module further comprises a mechanism to provide the community of members with a means to accept, reject, or counter the aggregate purchase offer from the merchant.

3. The system of claim 1, wherein the community of members interoperates with a social network.

4. A method for identifying and purchasing retail products, the method comprising the steps of:
creating, on a computing device, a community of members where the community of members are connected by a network;
identifying by a member of the community of members a desired product or service;
uploading information related to the desired product or service to a network;
making the information related to the desired product or service available to members of the community of members based on a selection criteria;
aggregating purchase offers for the desired product or service from members of the community of members;
transmitting to a merchant an aggregate purchase price and a quantity of purchase offers from members of the community of members;
providing a mechanism for the merchant to either accept the aggregate purchase price or to provide a counter-offer comprising a new purchase price; and
providing a mechanism for members of the community of members to either accept the counter-offer or to provide a new counter-offer to the merchant.

5. The method of claim 4, wherein a selection criterion is historical buying preferences.

6. The method of claim 4, wherein a selection criterion is member specified buying preferences.

7. The method of claim 4, wherein a selection criterion is a neighborhood the member belongs to.

8. The method of claim 4, wherein the network has a social network component.

9. The method of claim 4, wherein the network is an internet.

10. The method of claim 4, wherein the network is a computer network.

11. The method of claim 4, wherein the community of members interoperates with a social network.

12. The method of claim 4, wherein information related to the desired product or service comprises a picture of the desired product or service.

13. The method of claim 4, wherein information related to the desired product or service comprises a description of the desired product or service.

14. The method of claim 4, wherein information related to the desired product or service comprises a price for the desired product or service.

15. The method of claim 4, wherein information related to the desired product or service comprises merchant information for the desired product or service.

16. The method of claim 4, wherein the aggregate purchase price is an average purchase price from all members of the community of members that tendered an offer to purchase the desired product or service.

17. The method of claim 4, further comprising the step of providing a mechanism for the merchant to accept or reject the counter-offer from members of the community of members.

18. The method of claim 17, further comprising the step of providing a mechanism for the merchant to provide a counter-offer to the members of the community of members.

19. The method of claim 18, further comprising the step of providing a mechanism for the members of the community of members to accept or reject the counter-offer from the merchant.

20. A tangible computer-readable medium having instructions stored thereon, the instructions comprising:
instructions to establish and manage a community of members;
instructions to provide a mechanism for the community of members to interact;
instructions to provide information related to a desired product or service to members of the community of members;
instructions to aggregate purchase offers for the desired product or service from members of the community of members;
instructions to transmit to a merchant an aggregate purchase price and a quantity of purchase offers from members of the community of members;
instructions to allow a merchant to either accept the aggregate purchase price or to provide a counter-offer comprising a new purchase price; and
instructions to allow the members of the community of members to either accept the counter-offer or to provide a new counter-offer to the merchant.

21. The tangible computer-readable medium of claim 20, wherein the community of members interoperates with a social network.

22. The tangible computer-readable medium of claim 20, wherein information related to the desired product or service comprises a picture of the desired product or service.

23. The tangible computer-readable medium of claim 20, wherein information related to the desired product or service comprises a description of the desired product or service.

24. The tangible computer-readable medium of claim 20, wherein information related to the desired product or service comprises a price for the desired product or service.

25. The tangible computer-readable medium of claim 20, wherein information related to the desired product or service comprises merchant information for the desired product or service.

26. The tangible computer-readable medium of claim 20, wherein the aggregate purchase price is an average purchase price from all members of the community of members that tendered an offer to purchase the desired product or service.

27. The tangible computer-readable medium of claim 20, further comprising instructions to provide a mechanism for the merchant to accept or reject the counter-offer from members of the community of members.

28. The tangible computer-readable medium of claim 20, further comprising instructions to provide a mechanism for the merchant to provide a counter-offer to the members of the community of members.

29. The tangible computer-readable medium of claim 20, further comprising instructions to provide a mechanism for the members of the community of members to accept or reject the counter-offer from the merchant.
